(19) United States
(12) Patent Application Publication
(10) Pub. No.: US 2026/0259569 A1
(43) Pub. Date: Sep. 3, 2026

(54) CONTROL METHOD, PROGRAM, AND MOBILE BODY

(71) Applicant: MITSUBISHI HEAVY INDUSTRIES, LTD., Tokyo (JP)

(72) Inventors: Kenji TAKAO, Tokyo (JP); Yohei CHISHIKI, Tokyo (JP)

(73) Assignee: MITSUBISHI HEAVY INDUSTRIES, LTD., Tokyo (JP)

(21) Appl. No.: 19/474,263

(22) PCT Filed: Feb. 14, 2024
(86) PCT No.: PCT/JP2024/004938

§ 371 Date: Oct. 10, 2025

(30) Foreign Application Priority Data
Apr. 18, 2023 (JP) 2023-067963

(51) Int. Cl. G05D 1/65; B66F 9/06; B66F 9/075; G05D 1/622; G05D 1/644; G05D 105/28; G05D 107/70; G05D 109/10

(52) U.S. Cl. CPC G05D 1/65; B66F 9/063; B66F 9/0755; G05D 1/622; G05D 1/644; G05D 2105/28; G05D 2107/70; G05D 2109/10

(57) ABSTRACT

The present invention ensures early arrival at a target position while minimizing interference with other objects being conveyed. This control method for controlling a mobile body that moves automatically comprises: a step for setting, as a target position for a mobile body, a position corresponding to a prescribed unit region within an arrangement region where unit regions in which an object is likely to be arranged are aligned side by side in a first direction; a step for acquiring information about other objects that are arranged in unit regions other than the target position; a step for setting a route for the mobile body heading for the target position by passing through the arrangement region without interfering with other objects; and a step for moving the mobile body according to the route. The moving speed of the mobile body within the arrangement region and/or the section of the route that passes through the arrangement region is set on the basis of the information about the other objects.

### TECHNICAL FIELD

The present disclosure relates to a control method, a program, and a mobile body.

### BACKGROUND ART

A mobile body that autonomously moves and transports cargo is known. For example, PTL 1 discloses an autonomous transport vehicle that runs at a low speed when there is a worker in a running region and that runs at a high speed when there is no worker in the running region.

### CITATION LIST

### Patent Literature

[PTL 1] Japanese Unexamined Patent Application Publication No. 2000-187513

### SUMMARY OF INVENTION

### Technical Problem

Here, the mobile body may move toward a target position while moving in a region in which another transport object is likely to be placed. Therefore, in such a case, it is required to quickly reach the target position while suppressing interference with the other transport object.

An object of the present disclosure is to provide a control method, a program, and a mobile body that enable, when a mobile body moves toward a target position while moving in a region in which other transport object is likely to be placed, the target position to be quickly reached while suppressing interference with the other transport object.

### Solution to Problem

A control method according to the present disclosure is a control method for a mobile body that autonomously moves, the control method including: a step of setting a position corresponding to a predetermined unit region within an arrangement region in which unit regions in which an object is likely to be arranged are aligned in a first direction, as a target position of the mobile body; a step of acquiring information on another object that is the object arranged within the unit region other than the target position; a step of setting a route of the mobile body toward the target position through the arrangement region without interfering with the other object; and a step of moving the mobile body along the route, in which at least one of a moving speed of the mobile body within the arrangement region and a section that passes through the arrangement region on the route is set based on the information on the other object.

A program according to the present disclosure is a program causing a computer to execute a control method for a mobile body that autonomously moves, the control method including: a step of setting a position corresponding to a predetermined unit region within an arrangement region in which unit regions in which an object is likely to be arranged are aligned in a first direction, as a target position of the mobile body; a step of acquiring information on another object that is the object arranged within the unit region other than the target position; a step of setting a route of the mobile body toward the target position through the arrangement region without interfering with the other object; and a step of moving the mobile body along the route, in which at least one of a moving speed of the mobile body within the arrangement region and a section that passes through the arrangement region on the route is set based on the information on the other object.

A mobile body according to the present disclosure is a mobile body that autonomously moves, the mobile body including: a route acquisition unit that acquires a route of the mobile body; and a movement control unit that moves the mobile body along the route, in which, by setting a position corresponding to a predetermined unit region within an arrangement region in which unit regions in which an object is likely to be arranged are aligned in a first direction, as a target position of the mobile body, and acquiring information on another object that is the object arranged within the unit region other than the target position, the route is set to be directed toward the target position through the arrangement region without interfering with the other object, and at least one of a moving speed of the mobile body within the arrangement region and a section that passes through the arrangement region on the route is set based on the information on the other object.

### Advantageous Effects of Invention

According to the present disclosure, when the mobile body moves toward the target position while moving in a region in which other transport object is likely to be placed, it is possible to quickly reach the target position while suppressing interference with the other transport object.

### BRIEF DESCRIPTION OF DRAWINGS

FIG. 1 is a schematic diagram of a movement control system according to the present embodiment.

FIG. 2 is a schematic diagram of a configuration of a mobile body.

FIG. 3 is a schematic block diagram of a management device.

FIG. 4 is a schematic block diagram of an information processing device.

FIG. 5 is a schematic block diagram of a control device of the mobile body.

FIG. 6 is a schematic diagram showing an example of a first route.

FIG. 7 is a schematic diagram showing an example of a second route.

FIG. 8 is a flowchart showing a processing flow of the movement control system.

FIG. 9 is a schematic diagram showing an example of a first route.

FIG. 10 is a schematic diagram showing an example of a second route.

FIG. 11 is a schematic diagram showing an example of control of a mobile body according to a third embodiment.

FIG. 12 is a flowchart showing a processing flow of a movement control system according to the third embodiment.

### DESCRIPTION OF EMBODIMENTS

Hereinafter, preferred embodiments of the present disclosure will be described in detail with reference to the accompanying drawings. It should be noted that the present disclosure is not limited to the embodiments, and includes, in a case in which there are a plurality of embodiments, a configuration in which the embodiments are combined.

### First Embodiment

### Movement Control System

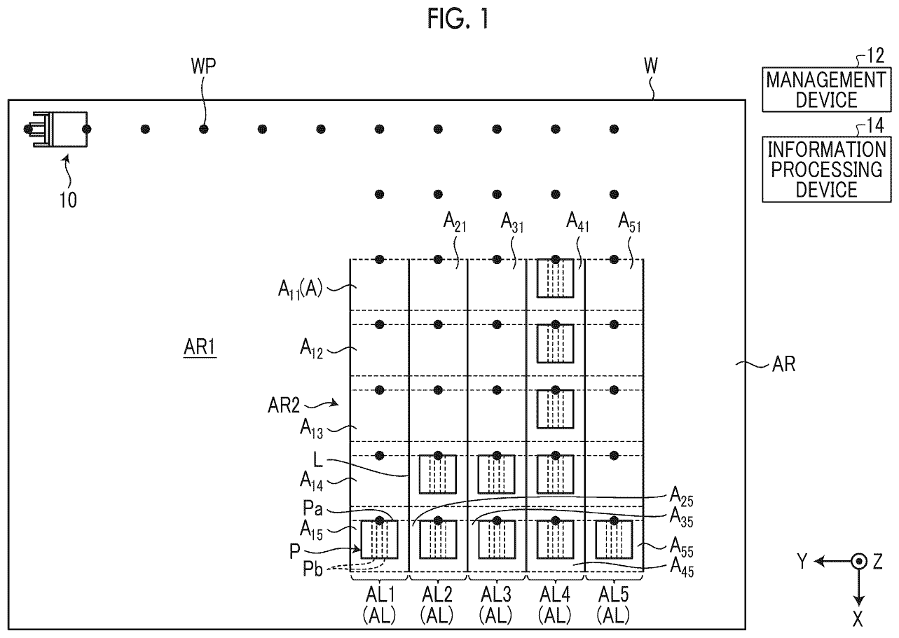

FIG. 1 is a schematic diagram of a movement control system according to the present embodiment. As shown in FIG. 1, a movement control system 1 according to the present embodiment includes a mobile body 10, a management device 12, and an information processing device 14. The movement control system 1 is a system that controls movement of the mobile body 10 belonging to a facility W. The facility Wis, for example, a facility subjected to logistics management, such as a warehouse, but may be any facility that operates the mobile body 10. In the movement control system 1, the mobile body 10 picks up and transports an object P arranged within a region AR of the facility W. The region AR is a region in which the object P is installed or the mobile body 10 moves, and is, for example, a floor surface of the facility W. In the present embodiment, the object P transported by the mobile body 10 is a transport object with cargo loaded on a pallet. However, the object P is not limited to the object with cargo loaded on the pallet, and may be in any form, for example, may be an object with only the cargo without the pallet. In addition, the mobile body 10 is not limited to the mobile body that transports the object P, and may be a device that moves in the facility W for any purpose.

Hereinafter, one direction along the region AR will be referred to as an X direction, and a direction along the region AR that intersects the X direction will be referred to as a Y direction. In the present embodiment, the Y direction is a direction orthogonal to the X direction. The X direction and the Y direction may be referred to as directions along a horizontal plane. Further, a direction orthogonal to the X direction and the Y direction, more specifically, a direction toward an upper side in a vertical direction, will be referred to as a Z direction. In addition, in the present embodiment, the term “position” refers to a position (coordinates) in a coordinate system (coordinate system of the region AR) on a two-dimensional plane in the region AR, unless otherwise noted. In addition, the term “posture (orientation)” of the mobile body 10 or the like refers to an orientation of the mobile body 10 or the like in the coordinate system of the region AR, and indicates a yaw angle (rotation angle) of the mobile body 10 when the X direction is set to 0° when the mobile body 10 or the like is viewed in the Z direction, unless otherwise noted.

### Arrangement Region

As shown in FIG. 1, an arrangement region AR2 is set in the region AR. The arrangement region AR2 is a region in which unit regions A in which the object P is likely to be installed are aligned in a first direction (X direction in the present example) along the region AR. The arrangement region AR2 is a region in which the mobile body 10 can move, in other words, the mobile body 10 can move through a region in which the object P is not arranged within the arrangement region AR2. In the present embodiment, the arrangement region AR2 is set on the floor surface of the facility W, and is, for example, a temporary placement region for the object P set on the floor surface. That is, for example, the object P loaded on a transport vehicle that has transported the object P to the facility W is temporarily placed within an installation region AR2, and the object P within the installation region AR2 is transported to another location (for example, a placement region such as a shelf) in the facility W. However, the use of the installation region AR2 is not limited to the temporary placement region. The installation region AR2 may be a region for any use in which the object P is installed.

The unit region A is a region set for installation of the object P. A shape and a size of the unit region A are set in advance. In the example of FIG. 1, the unit region A is rectangular, but the shape and the size thereof may be arbitrary. In addition, the unit region A is partitioned for each object P, and one object P is arranged in each unit region A. In each unit region A, depending on a status of the facility W, there are a case in which the object P is arranged and a case in which the object P is not arranged.

In the present embodiment, the installation region AR2 is a region in which installation lines AL, in which the unit regions A are aligned in the first direction (X direction in the present example), are aligned in a second direction (Y direction in the present example) intersecting the first direction. In other words, the installation region AR2 is a region in which the unit regions A are aligned in a matrix pattern in the X direction and the Y direction. No wall for preventing entry of the mobile body 10 is provided at an outer periphery of the installation region AR2 and between the unit regions A adjacent to each other within the installation region AR2. Therefore, the mobile body 10 can enter the installation region AR2 from outside the installation region AR2, and can move between the unit regions A within the installation region AR2. In the present embodiment, a line (for example, a white line) for visually recognizing a boundary between the installation lines AL is provided between the installation lines AL adjacent to each other in the Y direction, and extends in the X direction. In addition, a line (for example, a white line) for visually recognizing a boundary between the unit regions A may also be provided between the unit regions A adjacent to each other in the X direction. However, these lines are not essential. In addition, in the example of FIG. 1, five installation lines AL1, AL2, AL3, AL4, and AL5 that are aligned in the Y direction are provided as the installation lines AL, but the number of installation lines AL is not limited to this, and may be any plurality or one. In the example of FIG. 1, five unit regions A are provided within the installation line AL in the X direction. That is, the installation line AL1 is provided with unit regions A₁₁ to A₁₅ aligned in the X direction, the installation line AL2 is provided with unit regions A₂₁ to A₂₅ aligned in the X direction, the installation line AL3 is provided with unit regions A₃₁ to A₃₅ aligned in the X direction, the installation line AL4 is provided with unit regions A₄₁ to A₄₅ aligned in the X direction, and the installation line ALS is provided with unit regions A₅₁ to A₅₅ aligned in the X direction. However, the number of unit regions A within each installation line AL is not limited to this, and may be any plurality. In addition, the number of unit regions A provided within each installation line AL is the same for each installation line AL, but is not limited to this, and may be different for each installation line AL.

When the object P is arranged in the unit region A of the installation region AR2, the movement control system 1 controls the unloading to the unit region A by the mobile body 10 or the like so that a front surface Pa of the object P is arranged to face a direction opposite to the X direction. That is, within the unit region A in which the object P is arranged, the front surface Pa of the object P faces the direction opposite to the X direction. However, the present disclosure is not limited to a case where the front surfaces Pa of all the objects P face the direction opposite to the X direction, and, for example, the front surfaces Pa of at least some of the objects P may face a direction shifted from the direction opposite to the X direction. In addition, the front surface Pa of the object P refers to a surface on a side to which the mobile body 10 approaches. In the present embodiment, an opening Pb is formed in the front surface Pa of the object P, into which a fork 24, which will be described later, of the mobile body 10 is inserted.

The number of installation regions AR2 may be any number, and one installation region AR2 may be set in the facility W or a plurality of installation regions AR2 may be set in the facility W. In addition, a region in which the object P is arranged may be provided in a region of the facility W other than the installation region AR2. Hereinafter, a region other than the installation region AR2 in the region AR will be referred to as a normal region AR1.

### Waypoint

In the region AR, a waypoint WP is set for each position (coordinates). A first route R1, which will be described later, of the mobile body 10 is set to connect the waypoints WP. That is, a route that connects the waypoints WP through which the mobile body 10 is planned to pass is the first route R1 of the mobile body 10. The waypoint WP is set in accordance with the layout of the facility W, such as the position of the installation region AR2 and a passage. The waypoints WP are set, for example, in a matrix pattern in the region AR. Further, it is preferable that the waypoint WP is set for each unit region A within the installation region AR2. For example, the waypoint WP is set at a position (coordinates) corresponding to each unit region A. The position corresponding to the unit region A (position at which the waypoint WP is set) may be set as appropriate, and may be, for example, any position overlapping the unit region A. In the example of FIG. 1, the waypoint WP corresponding to the unit region A is set to a central position in the Y direction of the sides of the unit region A in the X direction and the direction side opposite to the X direction.

### Mobile Body

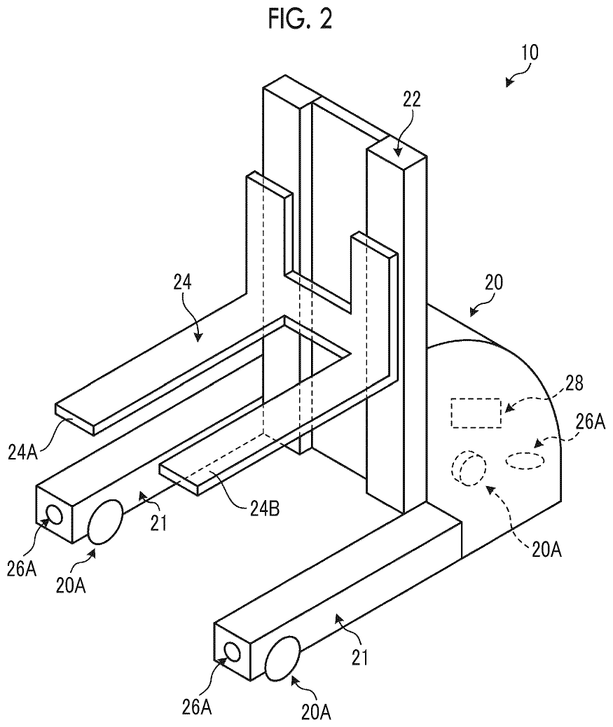

FIG. 2 is a schematic diagram of a configuration of the mobile body. The mobile body 10 is a device that can autonomously move. In the present embodiment, the mobile body 10 is a non-holonomic system that cannot move laterally. In the present embodiment, the mobile body 10 is a device that can transport a target object. Additionally, in the present embodiment, the mobile body 10 is a forklift, and more specifically, is a so-called automated guided vehicle (AGV) or an automated guided forklift (AGF). However, the mobile body 10 is not limited to the forklift that transports the target object, and may be any device that can autonomously move.

As shown in FIG. 2, the mobile body 10 includes a vehicle body 20, wheels 20A, straddle legs 21, a mast 22, a fork 24, a sensor 26A, and a control device 28. The straddle legs 21 are a pair of shaft-shaped members provided at one end portion of the vehicle body 20 in a front-rear direction and protruding from the vehicle body 20. The wheels 20A are provided at distal ends of the straddle legs 21 and on the vehicle body 20. That is, although three wheels 20A are provided in total, the positions and the number of wheels 20A may be arbitrary. The mast 22 is movably attached to the straddle legs 21 and moves in the front-rear direction of the vehicle body 20. The mast 22 extends along an up-down direction (here, the Z direction) orthogonal to the front-rear direction. The fork 24 is attached to the mast 22 to be movable in the Z direction. The fork 24 may also be movable relative to the mast 22 in a lateral direction (direction intersecting the up-down direction and the front-rear direction) of the vehicle body 20. The fork 24 has a pair of forks 24A and 24B. The forks 24A and 24B extend from the mast 22 toward the rear direction of the vehicle body 20. The fork 24A and the fork 24B are spaced apart from each other in the lateral direction of the mast 22. Hereinafter, in the front-rear direction, a direction on a side on which the fork 24 is provided in the mobile body 10 will be referred to as a rear direction, and a direction on a side on which the fork 24 is not provided will be referred to as a front direction.

The sensor 26A detects at least one of the position and the posture of the object present around the vehicle body 20. It can also be said that the sensor 26A detects at least one of the position of the object with respect to the mobile body 10 and the posture of the object with respect to the mobile body 10. In the present embodiment, the sensor 26A is provided at the distal end of each straddle leg 21 in the rear direction and on a front direction side of the vehicle body 20. However, a position at which the sensor 26A is provided is not limited to this, and the sensor 26A may be provided at any position, and the number of sensors 26A provided may also be arbitrary.

The sensor 26A is, for example, a sensor that emits laser light. The sensor 26A emits the laser light while performing scanning in one direction (here, the lateral direction), and detects the position and the orientation of the object from reflected light of the emitted laser light. That is, the sensor 26A can also be said to be a so-called two-dimensional (2D)-light detection and ranging (LiDAR) sensor. Here, the sensor 26A is not limited to the above-described sensor and may be a sensor that detects the object using any method, for example, a so-called three-dimensional (3D)-LiDAR that performs scanning in a plurality of directions, a so-called one-dimensional (1D)-LiDAR that does not perform scanning, or a camera.

The control device 28 controls the movement of the mobile body 10. The control device 28 will be described later.

### Management Device

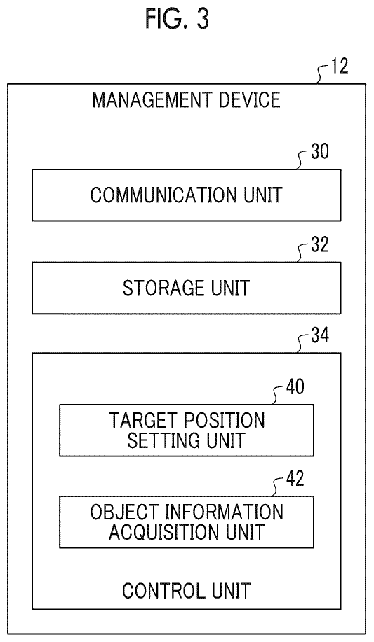

FIG. 3 is a schematic block diagram of the management device. The management device 12 is a system that manages logistics in the facility W. Although the management device 12 is a warehouse control system (WCS) or a warehouse management system (WMS) in the present embodiment, the management device 12 may be any system without being limited to a WCS and a WMS, and, for example, may be a back-end system such as another production management system. The position at which the management device 12 is provided is arbitrary, and the management device 12 may be provided in the facility W or may be provided at a position separate from the facility W to manage the facility W from that position. The management device 12 is a computer and includes, as shown in FIG. 3, a communication unit 30, a storage unit 32, and a control unit 34.

The communication unit 30 is a module used by the control unit 34 and communicating with an external device such as the information processing device 14, and may include, for example, an antenna. Although a communication method of the communication unit 30 is wireless communication in the present embodiment, the communication method may be arbitrary. The storage unit 32 is a memory that stores various types of information, such as arithmetic contents of the control unit 34 and programs, and includes, for example, at least one of a main storage device, such as a random-access memory (RAM) or a read-only memory (ROM), and an external storage device, such as a hard disk drive (HDD).

The control unit 34 is an arithmetic device, and includes, for example, an arithmetic circuit such as a central processing unit (CPU). The control unit 34 includes a target position setting unit 40 and an object information acquisition unit 42. The control unit 34 implements the target position setting unit 40 and the object information acquisition unit 42 by reading out the program (software) from the storage unit 32 and executing the program (software), and executes the processing thereof. The control unit 34 may execute the processing using one CPU or may include a plurality of CPUs and execute the processing using the plurality of CPUs. In addition, at least a part of the target position setting unit 40 and the object information acquisition unit 42 may be implemented by a hardware circuit. In addition, the program for the control unit 34 stored in the storage unit 32 may be stored in a recording medium that is readable by the management device 12.

The target position setting unit 40 sets a target position G, which is a movement destination of the mobile body 10. The object information acquisition unit 42 acquires installation object information, which is information on the object P placed in the facility W. Specific processing contents thereof will be described later.

The management device 12 may also execute processing other than the setting of the target position G and the acquisition of the installation object information. For example, the management device 12 may also set information for controlling a mechanism (for example, an elevator or a door) other than the mobile body 10 provided in the facility W.

### Information Processing Device

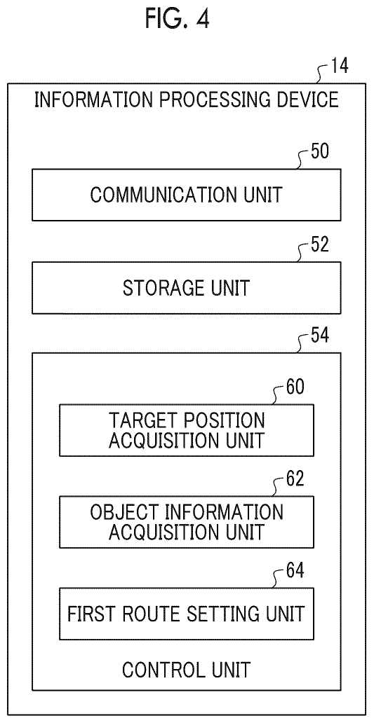

FIG. 4 is a schematic block diagram of the information processing device. The information processing device 14 is a device that processes information related to the movement of the mobile body 10. The information processing device 14 is, for example, a fleet control system (FCS) or a robot control system (RCS), but is not limited to this, and may be any device that processes information related to the movement of the mobile body 10. The information processing device 14 is a computer, and includes, as shown in FIG. 4, a communication unit 50, a storage unit 52, and a control unit 54. The communication unit 50 is a module used by the control unit 54 and communicating with an external device such as the management device 12 and the mobile body 10, and may include, for example, an antenna. Although a communication method of the communication unit 50 is wireless communication in the present embodiment, the communication method may be arbitrary. The storage unit 52 is a memory that stores various types of information, such as arithmetic contents of the control unit 54 and programs, and includes, for example, at least one of a main storage device such, as an RAM or an ROM, and an external storage device, such as an HDD.

The control unit 54 is an arithmetic device, and includes, for example, an arithmetic circuit such as a CPU. The control unit 54 includes a target position acquisition unit 60, an object information acquisition unit 62, and a first route setting unit 64. The control unit 54 implements the target position acquisition unit 60, the object information acquisition unit 62, and the first route setting unit 64 by reading out the program (software) from the storage unit 52 and executing the program (software), and executes the processing thereof. The control unit 54 may execute the processing using one CPU or may include a plurality of CPUs and execute the processing using the plurality of CPUs. In addition, at least a part of the target position acquisition unit 60, the object information acquisition unit 62, and the first route setting unit 64 may be implemented by a hardware circuit. In addition, the program for the control unit 54 stored in the storage unit 52 may be stored in a recording medium that is readable by the information processing device 14.

The target position acquisition unit 60 acquires information on the target position G, the object information acquisition unit 62 acquires installation object information which is information on the object P placed on the facility W, and the first route setting unit 64 sets the first route R1 of the mobile body 10. Specific processing contents thereof will be described later.

In addition, in the present embodiment, the management device 12 and the information processing device 14 are separate devices, but may be integrated into one device. That is, the management device 12 may have at least some functions of the information processing device 14, and the information processing device 14 may have at least some functions of the management device 12.

### Control Device of Mobile Body

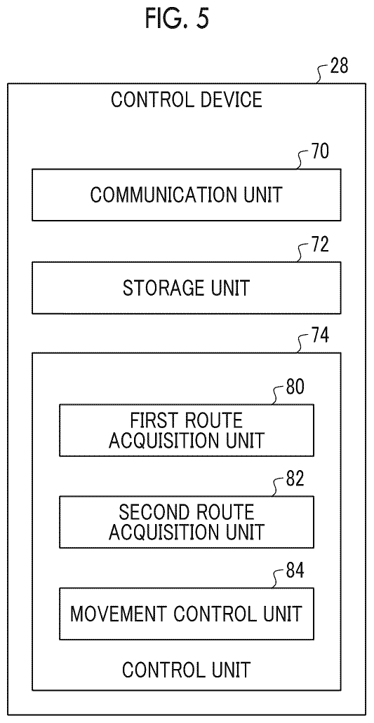

Next, the control device 28 of the mobile body 10 will be described. FIG. 5 is a schematic block diagram of the control device of the mobile body. The control device 28 is a device that controls the mobile body 10. The control device 28 is a computer, and includes, as shown in FIG. 5, a communication unit 70, a storage unit 72, and a control unit 74. The communication unit 70 is a module used by the control unit 74 and communicating with an external device such as the information processing device 14, and may include, for example, an antenna. Although a communication method of the communication unit 70 is wireless communication in the present embodiment, the communication method may be arbitrary. The storage unit 72 is a memory that stores various types of information, such as arithmetic contents of the control unit 74 and programs, and includes, for example, at least one of a main storage device, such as an RAM or an ROM, and an external storage device, such as an HDD.

The control unit 74 is an arithmetic device, and includes, for example, an arithmetic circuit such as a CPU. The control unit 74 includes a first route acquisition unit 80, a second route setting unit 82, and a movement control unit 84. The control unit 74 implements the first route acquisition unit 80, the second route setting unit 82, and the movement control unit 84 by reading out the program (software) from the storage unit 72 and executing the program (software), and executes the processing thereof. The control unit 74 may execute the processing using one CPU or may include a plurality of CPUs and execute the processing using the plurality of CPUs. In addition, at least a part of the first route acquisition unit 80, the second route setting unit 82, and the movement control unit 84 may be implemented by a hardware circuit. In addition, the program for the control unit 74 stored in the storage unit 72 may be stored in a recording medium that is readable by the control device 28.

The first route acquisition unit 80 acquires information on the first route R1, the second route setting unit 82 sets a second route R2 based on the first route R1, and the movement control unit 84 controls a movement mechanism such as a drive unit or steering of the mobile body 10 to control the movement of the mobile body 10. Specific processing contents thereof will be described later. In the present embodiment, the mobile body 10 sets the second route R2 in this way, but the present disclosure is not limited to this, as will be described later, and, for example, the information processing device 14 may set the second route R2 and transmit the second route R2 to the mobile body 10.

### Processing of Movement Control System

Hereinafter, processing contents of the movement control system 1 will be described.

### Setting of Target Position

The target position setting unit 40 of the management device 12 sets the target position G, which is the movement destination of the mobile body 10. In the present embodiment, the description is made with an example in which the mobile body 10 moves to the unit region A within the installation region AR2, and thus the target position setting unit 40 sets the position corresponding to the unit region A, which is the movement destination, as the target position G. For example, the target position setting unit 40 selects a waypoint WPG corresponding to the unit region A that is the movement destination, and sets the waypoint WPG as the target position G. The target position setting unit 40 may set any unit region A (waypoint WP) within the installation region AR2 as the target position G, and, for example, may set the unit region A (waypoint WP) as the target position G based on preset order information indicating the object P to be transported and a transport source and a transport destination of the object P.

The management device 12 transmits position information of the set target position G to the information processing device 14. That is, it can be said that the target position acquisition unit 60 of the information processing device 14 acquires the position information of the target position G set by the target position setting unit 40 of the management device 12. The position information of the target position G may be any information indicating the position of the target position G, and, for example, may be information indicating coordinates of the target position G or information indicating an identifier of the waypoint WPG corresponding to the target position G.

### Acquisition of Installation Object Information

The object information acquisition unit 42 of the management device 12 acquires the installation object information, which is the information on the object P placed in the facility W. The installation object information includes object information indicating the object P placed in the facility W and installation information indicating a position at which the object P is placed. For example, an identifier may be assigned to each object P, and information indicating the identifier may be used as the object information. In addition, the installation information may be position information of the object P within the facility W, may be information indicating coordinates at which the object P is installed, or may be information indicating an identifier assigned to each position (for example, the waypoint WP) at which the object P is installed. The object information acquisition unit 42 may acquire the installation object information using any method. For example, when the mobile body 10 unloads the object P, the mobile body 10 may transmit information on the object P and information on the unloaded position to the management device 12, and the object information acquisition unit 42 may acquire the pieces of information as the installation object information.

The installation object information includes the object information of the object P placed in each unit region A of the installation region AR2 and the installation information of the object P. Further, the installation object information includes information on the objects P arranged within the unit region A other than the target position G of the installation region AR2. That is, the object P arranged within the unit region A other than the unit region A corresponding to the target position G while the mobile body 10 is moving toward the target position G is defined as another object. In this case, it can be said that the installation object information includes installation information of the other object. That is, it can be said that the object information acquisition unit 42 acquires the installation information (position information of the unit region A in which the other object is placed or position information of the waypoint WP corresponding to the unit region A) of the object P (other object) arranged within the unit region A other than the target position G.

The management device 12 transmits the acquired installation object information to the information processing device 14. That is, it can be said that the object information acquisition unit 62 of the information processing device 14 acquires the installation object information from the management device 12.

### Setting of First Route

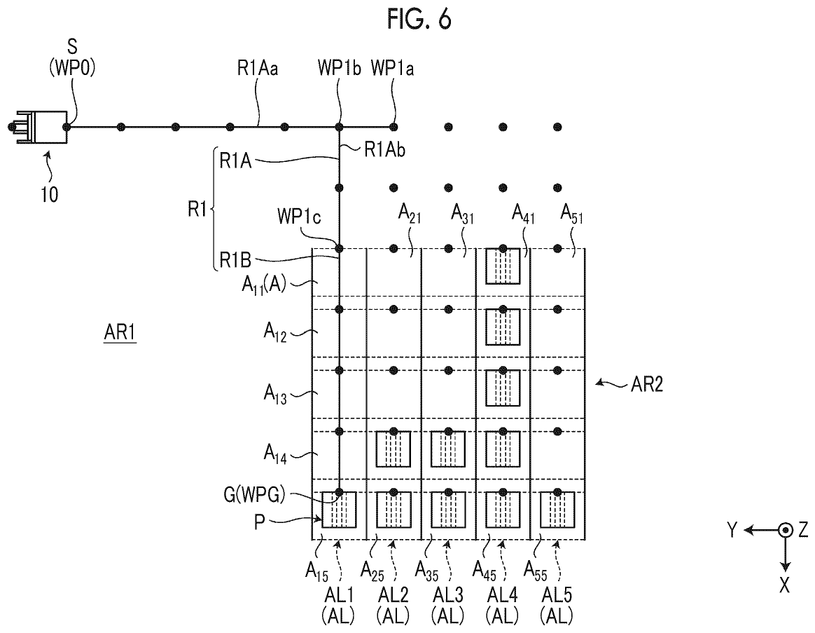

FIG. 6 is a schematic diagram showing an example of the first route. The first route setting unit 64 of the information processing device 14 sets the first route R1 of the mobile body 10 based on the installation object information and the position information of the target position G. However, the entity responsible for setting the first route R1 is not limited to the information processing device 14, and may be the control device 28 of the mobile body 10. In such a case, the control device 28 of the mobile body 10 may execute the processing of the target position acquisition unit 60, the object information acquisition unit 62, and the first route setting unit 64.

The first route R1 may be referred to as a layout path. In the present embodiment, the first route setting unit 64 sets a route toward the target position G through the arrangement region AR2 without interfering with the other object, as the first route R1, based on the installation information of the other object (position information of the object P arranged within the unit region A other than the target position G) and the position information of the target position G. In the present embodiment, the first route setting unit 64 sets a route that connects the waypoints WP from a movement source S to the target position G of the mobile body 10 as the first route R1. That is, the first route setting unit 64 selects the waypoints WP that connect the movement source S to the target position G while keeping a distance from the other object to be equal to or greater than a predetermined distance, and sets a route that connects the waypoints WP as the first route R1. The position of the movement source S may be set arbitrarily, and, for example, the waypoint WP closest to a position at which the mobile body 10 starts moving may be set as the movement source S. In the example of the present embodiment, the movement source S is located within the normal region AR1 (outside the installation region AR2), but the movement source S may be located within the installation region AR2. That is, the first route R1 may be a route from within the installation region AR2 to another location within the same installation region AR2.

The first route setting unit 64 sets the first route R1 to include an approach section RIB that reaches the target position G toward the X direction within the arrangement region AR2. More specifically, as shown in FIG. 6, the first route setting unit 64 sets the first route R1 to include an out-of-region section R1A and the approach section R1B.

### Out-of-Region Section

The out-of-region section R1A is a section from the movement source S to a starting point of the approach section RIB on the first route R1. In the example of the present embodiment, since the movement source S is outside the arrangement region AR2 (that is, within the normal region AR1), the out-of-region section RIA is a section from the movement source S toward the arrangement region AR2 through the outside of the arrangement region AR2. In the example of the present embodiment, the out-of-region section RIA is a section (section that connects the waypoints WP within the normal region AR1 from the waypoint WP of the movement source S to the waypoint WP of the boundary position) that passes through the normal region AR1 from the movement source S within the normal region AR1 to a boundary position between the normal region AR1 and the arrangement region AR2. However, when the movement source S is located within the arrangement region AR2, the out-of-region section R1A may be a section from the movement source S within the arrangement region AR2 toward the starting point of the approach section RIB, which will be described later.

Further, it is preferable that the out-of-region section R1A includes a section R1Aa and a section R1Ab. The section R1Aa is a section from the movement source S to the waypoint WP located on a side opposite to the X direction with respect to the installation line AL including the target position G. Since the mobile body 10 can move at a high speed in the section R1Aa, the mobile body 10 may move in the front direction in which the fork 24 is not provided, as a running direction. In such a case, it is preferable that the section R1Aa also includes a section for the mobile body 10 to turn back (making the orientation of the vehicle body opposite to the running direction). In the example of FIG. 6, as the section R1Aa, a route that connects the waypoints from a waypoint WP0 corresponding to the movement source S to a waypoint WP1a located on a side opposite to the waypoint WP0 with respect to a waypoint WP1b located on a side opposite to the X direction with respect to the installation line AL1 including the target position G through the waypoint WP1b is set. The section from the waypoint WP0 to the waypoint WP1b is a section in which the mobile body 10 moves in the front direction in which the fork 24 is not provided, as the running direction, and the section returning from the waypoint WP1b to the waypoint WP1a is a section in which the mobile body 10 turns back, switches the running direction to the rear direction in which the fork 24 is provided, and reaches the waypoint WP1b. However, it is not essential to provide the section for turning back. For example, when a distance from the movement source S to the target position G is short, the mobile body 10 may move through the section R1Aa in the rear direction in which the fork 24 is provided, as the running direction instead of the front direction in which the fork 24 is not provided, without using the front direction as the running direction. In such a case, the section for turning back is not necessary.

The section R1Ab is a section that connects, along the X direction, the waypoint WP located on the side opposite to the X direction with respect to the installation line AL including the target position G to the waypoint WP (boundary position between the normal region AR1 and the arrangement region AR2) located farthest on the side opposite to the X direction with respect to the installation line AL including the target position G. In the example of FIG. 6, a route that connects, along the X direction, the waypoints from the waypoint WP1b located on the side opposite to the X direction with respect to the installation line AL1 including the target position G to a waypoint WP1c (waypoint corresponding to the unit region A₁₁) located farthest on the side opposite to the X direction on the installation line AL1 is set as the section R1Ab.

In this way, the out-of-region section RIA is a section that passes outside the arrangement region AR2, but may pass through the arrangement region AR2, which is different from the arrangement region AR2 in which the target position G is set, in some sections.

### Approach Section

The approach section RIB is a section that reaches the target position G through the arrangement region AR2 along the X direction on the first route R1. It can be said that the approach section RIB is a section that reaches the target position G through the unit region A in which the object P is not arranged within the arrangement region AR2. In the example of the present embodiment, the approach section RIB is connected to the out-of-region section R1A. That is, the approach section RIB is a section that connects, in the X direction within the installation line AL including the target position G, a boundary position that is an end point of the out-of-region section R1A (waypoint WP located farthest on the side opposite to the X direction within the installation line AL including the target position G) between the normal region AR1 and the arrangement region AR2 to the target position G. In the example of FIG. 6, the object P (other object) is not located in the unit regions A₁₁ to A₁₄ within the installation line AL1, and the target position G is set to a position corresponding to the unit region A₁₅ within the installation line AL1. Therefore, the approach section RIB is a route that connects, in the X direction within the installation line AL1, the waypoint Wp1c corresponding to the unit region A₁₁ to the waypoint WPG corresponding to the unit region A₁₅.

The information processing device 14 transmits information on the set first route R1 to the mobile body 10. That is, the first route acquisition unit 80 of the mobile body 10 acquires the information on the first route R1 set by the information processing device 14. Although the information on the first route R1 may be any information indicating the position of the first route R1, in the present embodiment, the information may be the position information of the waypoint WP included in the first route R1.

In this way, in the present embodiment, the information processing device 14 sets the first route R1, but the entity responsible for setting the first route R1 is not limited to the information processing device 14 and may be arbitrary. For example, the first route acquisition unit 80 of the mobile body 10 may set the first route R1 using the same method as described above.

### Setting of Second Route

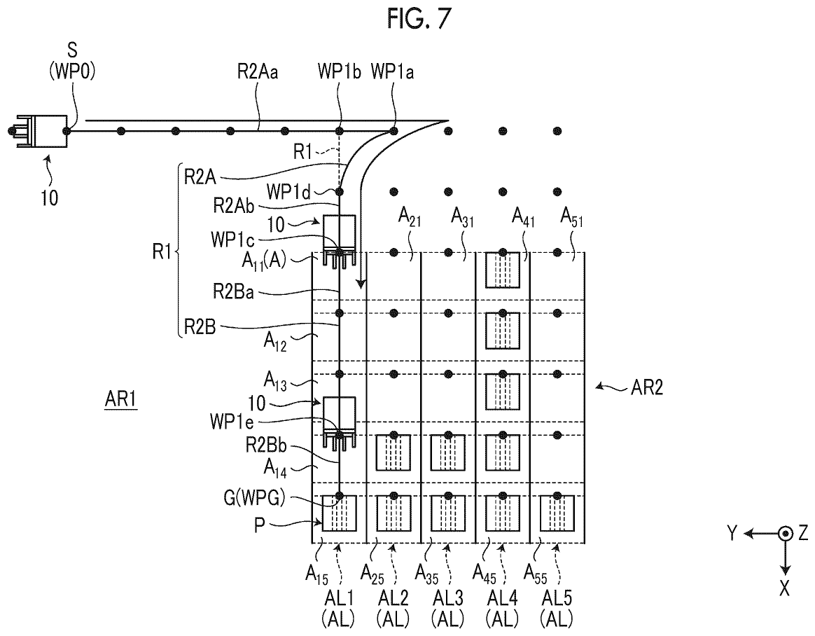

FIG. 7 is a schematic diagram showing an example of the second route. The second route setting unit 82 of the mobile body 10 sets the second route R2 based on the first route R1. The second route R2 may also be referred to as a running path. More specifically, the second route setting unit 82 sets the second route R2 based on the first route R1 and information on vehicle specifications of the mobile body 10. The information on the vehicle specifications is, for example, a specification that affects a route along which the mobile body 10 can move, such as the size or the minimum turning radius of the mobile body 10. The second route R2 is also a route toward the target position G through the arrangement region AR2 without interfering with the other object, as in the first route R1. Further, the second route R2 is a route on which the mobile body 10 can follow and which reaches the target position G while passing within a predetermined distance from the first route R1.

In the present embodiment, the second route setting unit 82 sets the second route R2 to include an approach section R2B that reaches the target position G toward the X direction within the arrangement region AR2. The second route setting unit 82 sets the second route R2 to include an out-of-region section R2A corresponding to the out-of-region section R1A of the first route R1 and the approach section R2B corresponding to the approach section R1B of the first route R1.

The out-of-region section R2A is a section toward the arrangement region AR2 through the outside of the arrangement region AR2 (that is, through the normal region AR1) on the second route R2. In the example of the present embodiment, it can be said that the out-of-region section R2A is a section that passes through the normal region AR1 from the movement source S to the boundary position between the normal region AR1 and the arrangement region AR2.

Further, it is preferable that the out-of-region section R2A includes a section R2Aa corresponding to the section R1Aa of the first route R1 and a section R2Ab corresponding to the section R1Ab of the first route R1. The section R2Aa is a section from the movement source S to the waypoint WP located on a side opposite to the X direction with respect to the installation line AL including the target position G. In the section R2Aa (section R1Aa), when the mobile body 10 moves in the front direction in which the fork 24 is not provided, as the running direction, it is preferable that the section R2Aa also includes a section for the mobile body 10 to turn back. In the example of FIG. 7, as the section R2Aa, a route that connects the waypoint WP0 corresponding to the movement source S to the waypoint WP1a and a route that connects the waypoint WP1a to a waypoint WP1d in a curved shape are set. The waypoint WP1d is a waypoint WP located on the side opposite to the X direction with respect to the installation line AL1 including the target position G. However, in the section R2Aa (section R1Aa), when the mobile body 10 moves in the rear direction in which the fork 24 is provided, as the running direction, it is not necessary to set the section for turning back.

The section R2Ab is a section that connects, along the X direction, the waypoint WP located on the side opposite to the X direction with respect to the installation line AL including the target position G to the waypoint WP (boundary position between the normal region AR1 and the arrangement region AR2) located farthest on the side opposite to the X direction with respect to the installation line AL including the target position G. In the example of FIG. 7, as the section R2Ab, a route that connects, along the X direction, the waypoints from the waypoint WP1d to the waypoint WP1c corresponding to the unit region A₁₁ is set.

The approach section R2B is a section that reaches the target position G through the arrangement region AR2 along the X direction on the second route R2. It can be said that the approach section R2B is a section that reaches the target position G through the unit region A in which the object P is not arranged within the arrangement region AR2. In the example of the present embodiment, the approach section R2B is connected to the out-of-region section R2A. That is, the approach section R2B is a section that connects, in the X direction within the installation line AL including the target position G, a boundary position that is an end point of the out-of-region section R2A (waypoint WP located farthest on the side opposite to the X direction within the installation line AL including the target position G) between the normal region AR1 and the arrangement region AR2 to the target position G. In the example of FIG. 7, the approach section R2B is a route that connects, in the X direction within the installation line AL1, the waypoint Wp1c corresponding to the unit region A₁₁ to the waypoint WPG corresponding to the unit region A₁₅.

In this way, in the present embodiment, the mobile body 10 sets the second route R2, but the entity responsible for setting the second route R2 is not limited to the mobile body 10 and may be arbitrary. For example, when the information processing device 14 sets the second route R2, the second route setting unit 82 of the mobile body 10 may acquire information on the second route R2 from the information processing device 14. In addition, in the present embodiment, the second route R2 is set based on the first route R1, but the method of setting the second route R2 is not limited to this and may be arbitrary. The second route R2 may be set using any method based on the installation information of the other object and the position information of the target position G.

### Movement of Mobile Body

The movement control unit 84 of the mobile body 10 moves the mobile body 10 along the second route R2. The movement control unit 84 sequentially ascertains the position information of the mobile body 10, to move the mobile body 10 to pass through the second route R2. The method of acquiring the position information of the mobile body 10 is arbitrary, but, for example, in the present embodiment, a detection body (not shown) is provided in the facility W, and the movement control unit 84 acquires the information on the position and the posture of the mobile body 10 based on the detection of the detection body. Specifically, the mobile body 10 emits the laser light toward the detection body, receives reflected light of the laser light from the detection body, and detects the position and the posture of the first mobile body 10 in the facility W. The method of acquiring the information on the position and the posture of the mobile body 10 is not limited to the method using the detection body, and, for example, simultaneous localization and mapping (SLAM) may be used.

In the example of FIG. 7, the mobile body 10 moves along the section R2Aa from the waypoint WP0 to the waypoint WP1a in the front direction in which the fork 24 is not provided, as the running direction. Then, the mobile body 10 turns back at the waypoint WP1a, moves to the waypoint WP1d while turning along the section R2Aab in the rear direction in which the fork 24 is provided, as the running direction, and turns the running direction thereof at the waypoint WP1d toward the X direction. Then, the mobile body 10 moves from the waypoint WP1d to the waypoint WP1c along the section R2Ab. Then, the mobile body 10 moves from the waypoint WP1c to the waypoint WPG, which is the target position G, along the approach section R2B.

In the example of the present embodiment, the object P as the transport object is arranged in the unit region A corresponding to the target position G. Therefore, when the mobile body 10 reaches the waypoint WPG, which is the target position G, the movement control unit 84 controls the fork 24 so that the fork 24 is inserted into the opening Pb of the object P provided at the target position G and picks up the object P (picks up the cargo). In this case, the movement control unit 84 may cause the sensor 26A to detect the position and the posture of the front surface Pa of the object P from the waypoint WPG or from a position before reaching the waypoint WPG. Then, the movement control unit 84 may set a third route to the object P based on the position and the posture of the front surface Pa of the object P, approach the object P along the third route, and pick up the object P. That is, in such a case, the movement control unit 84 may set a third route in which the mobile body 10 has a predetermined position and posture (a position and a posture at which the mobile body 10 can pick up the object P) relative to the position and posture of the detected object P, and approach the object P along the third route. In addition, for example, the movement control unit 84 may cause the mobile body 10 to approach the object P by performing feedback control (direct feedback control) based on the detection result of the position and the posture of the object P and the detection result of the position and the posture of the mobile body 10. In this case, the control may be switched to the direct feedback control during the approach along the third route based on the position and the posture of the object P.

### Setting of Moving Speed

In the present embodiment, the movement control unit 84 sets a moving speed of the mobile body 10 within the arrangement region AR2 when the mobile body 10 moves along the second route R2 as described above. That is, the movement control unit 84 sets the moving speed of the mobile body 10 within the approach section R2B that passes through the arrangement region AR2 on the second route R2. Here, the approach section R2B is set not to interfere with the other object, based on the installation information of the other object. Therefore, it can be said that the movement control unit 84 sets the moving speed of the mobile body 10 within the arrangement region AR2, based on the installation information of the other object (the position information of the object P arranged within the unit region A other than the target position G).

More specifically, a position through which the mobile body 10 passes before the target position G in the approach section R2B on the second route R2, that is, a position between a starting point of the approach section R2B (waypoint WP1c in the example of FIG. 7) and the target position G (waypoint WPG in the example of FIG. 7), is set as an intermediate position. In addition, a section from the intermediate position in the approach section R2B is set as a first approach section R2Ba, and a section from the intermediate position in the approach section R2B to the target position G is set as a second approach section R2Bb. In this case, the movement control unit 84 sets the moving speed of the mobile body 10 in the first approach section R2Ba to be higher than the moving speed of the mobile body 10 in the second approach section R2Bb. The first approach section R2Ba may be a section from the starting point (waypoint WP1c in the example of FIG. 7) of the approach section R2B to the intermediate position.

The intermediate position may be set using any method. For example, a position on the approach section R2B spaced away from the target position G by a predetermined distance may be set as the intermediate position. The predetermined distance in this case may be set arbitrarily, but, for example, a running distance in the X direction, which is necessary for adjusting the orientation and the position of the mobile body 10 in the Y direction so that the fork 24 can be inserted into the opening Pb of the object P, may also be set as the predetermined distance. More specifically, a distance from a starting point (waypoint WP1d in the example of FIG. 7) of the section R2Ab of the out-of-region section R2A to the target position G (waypoint WPG in the example of FIG. 7) is set as a distance Dᵢⱼ. In addition, a running distance in the X direction, which is necessary for adjusting the orientation and the position of the mobile body 10 in the Y direction so that the fork 24 can be inserted into the opening Pb of the object P, is set as a distance Lf. In addition, a running distance in the X direction, which is necessary for the mobile body 10 to face the X direction by the turning, is set as a distance Lt. In addition, in the example of FIG. 7, the mobile body 10 turns and moves from the waypoint WP1a to face the X direction at the waypoint WP1d, and thus the distance Lt is a distance in the X direction between the waypoint WP1a and the waypoint WP1d. In this case, when “distance Dᵢⱼ≥distance Lf+distance Lt” is satisfied, the movement control unit 84 may set the position on the approach section R2B spaced away from the target position G to the side opposite to the X direction by the distance Lf, as the intermediate position. When “distance Dᵢⱼ≥distance Lf+distance Lt” is not satisfied, the movement control unit 84 may set the entire section of the approach section R2B as the second approach section R2Bb without setting the intermediate position, and set the moving speed to be low.

In addition, the movement control unit 84 may set the moving speed in the first approach section R2Ba, based on the information on the other object in the unit regions A located on the Y direction side and on a direction side opposite to the Y direction with respect to the first approach section R2Ba. That is, for example, when the unit region A adjacent to the unit region A, which overlaps the first approach section R2Ba, on the Y direction side or the side opposite to the Y direction is set as an adjacent unit region, the movement control unit 84 determines whether the object P is located in the adjacent unit region, based on the installation information of the other object. The movement control unit 84 sets the moving speed in the first approach section R2Ba when the object P is located in the adjacent unit region to be lower than the moving speed in the first approach section R2Ba when the object P is not located in the adjacent unit region. Further, for example, the first approach section R2Ba may be divided into a section in which the object P is located in the adjacent unit region and a section in which the object P is not located in the adjacent unit region, and the moving speed in the section in which the object P is located in the adjacent unit region may be lower than the moving speed in the section in which the object P is not located in the adjacent unit region. For example, the moving speed when the object P is located in the adjacent unit region may be set to be the same as the moving speed in the second approach section R2Bb.

In addition, the movement control unit 84 may perform different processing between a case where the other object is located on both sides in the Y direction with respect to the first approach section R2Ba and a case where the other object is located only on one side in the Y direction (the Y direction side or the side opposite to the Y direction) with respect to the first approach section R2Ba. In this case, for example, when the other object is located on both sides in the Y direction, the movement control unit 84 sets, as described above, the moving speed of the section in which the object P is located in the adjacent unit region to be lower than the moving speed of the section in which the object P is not located in the adjacent unit region. On the other hand, when the other object is located only on one side of the first approach section R2Ba in the Y direction, the movement control unit 84 may shift the first approach section R2Ba to be parallel to the side opposite to the Y direction (side on which the other object is not located) and move the mobile body 10 along the shifted first approach section R2Ba. In such a case, the moving speed of the first approach section R2Ba may be the same as the moving speed of the section in which the object P is not located in the adjacent unit region. When the mobile body 10 moves along the shifted first approach section R2Ba and approaches the object P at the target position G, the movement control unit 84 may cause the sensor 26A to detect the position and the posture of the front surface Pa of the object P. Then, the movement control unit 84 may set the third route to the object P based on the position and the posture of the front surface Pa of the object P, and approach the object P along the third route.

In addition, the movement control unit 84 sets the moving speed in the out-of-region section R2A to be higher than the moving speed in the approach section R2B. More specifically, the movement control unit 84 sets the moving speed in a section that passes through a region in which the object P is not allowed to be placed (region in which the region in which the object P is installed is not set) in the out-of-region section R2A to be higher than the moving speed in the approach section R2B.

In the present embodiment, the movement control unit 84 sets the moving speed in the first approach section R2Ba to be higher than the moving speed in the second approach section R2Bb, and sets the moving speed in the out-of-region section R2A to be even higher than the moving speed in the first approach section R2Ba. However, the present embodiment is not limited to this, and at least one of setting the moving speed in the first approach section R2Ba to be higher than the moving speed in the second approach section R2Bb and setting the moving speed in the out-of-region section R2A to be higher than the moving speed in the approach section R2B may be performed. The movement control unit 84 sets the moving speed of the mobile body 10 on the second route R2 as described above, and moves the mobile body 10 along the second route R2 at the set moving speed.

In the present embodiment, the moving speed of the mobile body 10 on the second route R2 is set by the mobile body 10, but the entity responsible for setting the moving speed is not limited to the mobile body 10 and may be arbitrary. For example, the information processing device 14 may set the moving speed, and the movement control unit 84 of the mobile body 10 may acquire information on the moving speed from the information processing device 14. In addition, in the present embodiment, the moving speed is set for each section of the second route R2, but the present disclosure is not limited to this, and the moving speed may be set for each section of the first route R1 using the same method as the above-described method. In such a case, the moving speed set for each section of the first route R1 is applied as the moving speed of each section of the second route R2 corresponding to each section of the first route R1

In addition, in the above description, the mobile body 10 picks up the object P installed in the unit region A corresponding to the target position G. However, the present disclosure is not limited to this, and the mobile body 10 may drop (unload) the object P in the unit region A corresponding to the target position G. In such a case as well, the first route R1 and the second route R2 may be set using the same method as the above description, and the moving speed may be set using the same method as the above description. In such a case, the mobile body 10 reaches the target position G along the second route R2 in a state of holding the object P, and unloads the object P to the unit region A corresponding to the target position G.

### Processing Flow

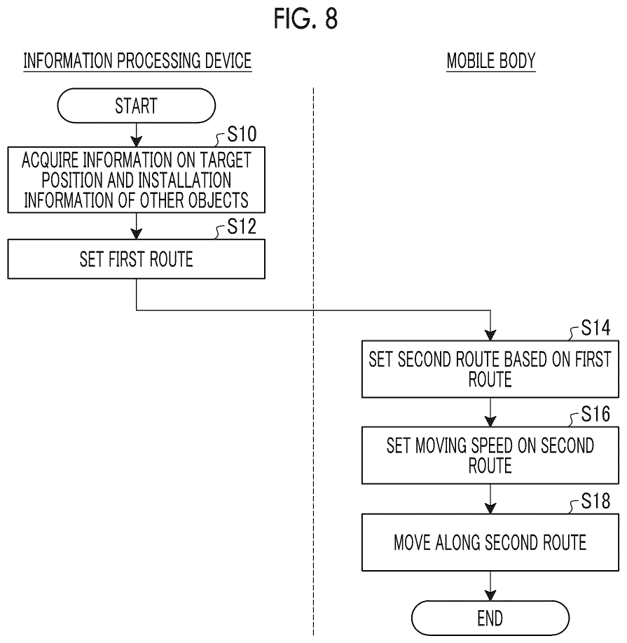

A flow of the above-described processing contents of the movement control system 1 will be described. FIG. 8 is a flowchart showing a processing flow of the movement control system. As shown in FIG. 8, the information processing device 14 acquires the information on the target position G and the installation information of the other object (step S10), and sets the first route R1 toward the target position G through the arrangement region AR2 without interfering with the other object, based on the information on the target position G and the installation information of the other object (step S12). The mobile body 10 acquires the information on the first route R1 from the information processing device 14, and sets the second route R2 toward the target position G through the arrangement region AR2 without interfering with the other object, based on the first route R1 (step S14). Then, the mobile body 10 sets the moving speed of each section on the second route R2 (step S16), and moves along the second route R2 at the set moving speed (step S18). In this processing flow, the moving speed on the second route R2 is set after the second route R2 is set, but the present disclosure is not limited to this. For example, the second route R2 may be set such that the moving speed satisfies a predetermined condition (for example, the moving speed is the maximum or the movement time is the minimum). Examples of the predetermined condition here include a condition in which the moving speed is the maximum and a condition in which the movement time is the minimum. In this case, for example, optimization calculation for obtaining the second route R2 in which the moving speed is the maximum or optimization calculation for obtaining the second route R2 in which the movement time is the minimum may be executed. Then, the second route R2 obtained by the optimization calculation is used as the second route R2 to be actually used, and the moving speed set in the optimization calculation is set as the moving speed on the second route R2.

### Effects

As described above, in the present embodiment, the route toward the target position G through the arrangement region AR2 without interfering with the other object is set, and the moving speed of the mobile body 10 within the arrangement region AR2 is set based on the information on the other object. Accordingly, it is possible to move within the arrangement region AR2 in which the unit regions are aligned in the X direction at an appropriate moving speed, and it is possible to quickly reach the target position while suppressing interference with the other object. More specifically, in the present embodiment, the moving speed outside the arrangement region AR2 (within the normal region AR1) is set to be higher than the moving speed in the arrangement region AR2 in which the object P is likely to be installed. Accordingly, it is possible to perform high-speed movement in the normal region AR1 in which the object P is not installed, while performing precise operation in the arrangement region AR2 in which the object P is likely to be installed, and therefore it is possible to quickly reach the target position while suppressing interference with the other object. In addition, in the present embodiment, the moving speed in the first approach section R2Ba to the intermediate position is set to be higher than the moving speed in the second approach section R2Bb from the intermediate position to the target position G. Therefore, it is possible to perform high-speed movement in the first approach section R2Ba that is located within the arrangement region AR2 but is spaced away from the target position G and to perform precise operation in the second approach section R2Bb that is close to the target position G, and therefore it is possible to quickly reach the target position G while approaching the target position G with high accuracy while avoiding interference with the other object.

### Second Embodiment

Hereinafter, a second embodiment will be described. In the first embodiment, the moving speed of the mobile body 10 within the arrangement region AR2 is set based on the information on the other object, but, in the second embodiment, a section (approach section) that passes through the arrangement region AR2 on the route of the mobile body 10 is set based on the information on the other object. The second embodiment may be combined with the first embodiment, but the processing of setting the moving speed in the first embodiment need not be performed. In other words, in the present disclosure, it is sufficient to set at least one of the moving speed of the mobile body 10 within the arrangement region AR2 and the section that passes through the arrangement region AR2, based on the information on the other object, and both the moving speed and the section may be set. The second embodiment will be described below, but the common configurations as those of the first embodiment will not be described.

In the second embodiment, the approach section that passes through the arrangement region AR2 is set based on the information of the other object. Hereinafter, a specific description will be made.

### Setting of First Route

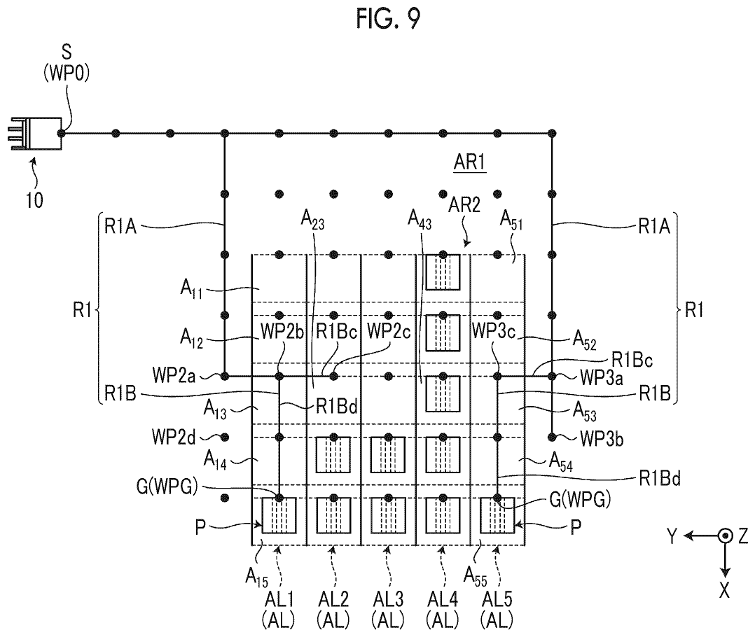

FIG. 9 is a schematic diagram showing an example of the first route. In the second embodiment, the first route setting unit 64 of the information processing device 14 sets the first route R1 to include the out-of-region section RIA and the approach section R1B, based on the position information of the other object and the position information of the target position G.

### Out-of-Region Section

As in the first embodiment, the out-of-region section R1A in the second embodiment is a section from a position outside the arrangement region AR2 (within the normal region AR1) toward the arrangement region AR2 through the outside of the arrangement region AR2. Here, a position (waypoint WP) within the arrangement region AR2 on a side opposite to the X direction with respect to the target position G, with no other object arranged within the unit region A between the position and the target position G, will be referred to as an immediately preceding position. In addition, a position (waypoint WP) within the normal region AR1 on the Y direction side or on a direction side opposite to the Y direction with respect to the immediately preceding position, with no other object arranged between the position and the immediately preceding position, will be referred to as an entry start position. The out-of-region section R1A of the second embodiment is a section that passes through the normal region AR1 with the movement source S as a starting point and the entry start position as an end point (section that connects the waypoints WP within the normal region AR1 from the waypoint WP of the movement source S to the waypoint WP of the entry start position).

In the example of FIG. 9, on the first route R1 in which the unit region A₁₅ is the target position G, a waypoint WP2b overlapping the unit region A₁₃ is set as the immediately preceding position, and a waypoint WP2a located on the Y direction side with respect to the waypoint WP2b is set as the entry start position. Therefore, the out-of-region section R1A in which the unit region A₁₅ is the target position G is a section that connects the movement source S (waypoint WP0) and the waypoint WP2a within the normal region AR1. Similarly, in the example of FIG. 9, on the first route R1 in which the unit region A₅₅ is the target position G, a waypoint WP3c overlapping the unit region A₅₃ is set as the immediately preceding position, and a waypoint WP3a located on the direction side opposite to the Y direction with respect to the waypoint WP3c is set as the entry start position. Therefore, the out-of-region section RIA in which the unit region A₅₅ is the target position G is a section that connects the movement source S (waypoint WP0) and the waypoint WP3a within the normal region AR1.

The first route setting unit 64 may include a section for the mobile body 10 to turn back in the out-of-region section R1A. For example, the first route setting unit 64 may determine whether the other object is placed in the unit region A (waypoint WP) adjacent to the immediately preceding position on a side opposite to the entry start position, based on the information on the other object, and when the other object is placed, the first route setting unit 64 may include the section for turning back in the out-of-region section RIA. On the other hand, when no other object is placed in the unit region A (waypoint WP) adjacent to the side opposite to the entry start position with respect to the immediately preceding position, for example, the section for turning back may be included in the approach section RIB without including the section for turning back in the out-of-region section R1A. In the example of FIG. 9, on the first route R1 in which the unit region A₁₅ is the target position G, the other object is not placed at a waypoint WP2c on a side opposite to the Y direction with respect to the waypoint WP2b which is the immediately preceding position, and thus the section for turning back is not included in the out-of-region section RIA. On the other hand, on the first route R1 in which the unit region A₅₅ is the target position G, the other object is placed at the waypoint WP on a side opposite to the Y direction with respect to the waypoint WP3c which is the immediately preceding position, and thus the section for turning back is included in the out-of-region section R1A. Specifically, in the out-of-region section R1A in which the unit region A₅₅ is the target position G, the section from the waypoint WP0 to the waypoint WP3b through the waypoint WP3a is a section for the mobile body 10 to move in the front direction in which the fork 24 is not provided, as the running direction, and the section returning from the waypoint WP3b to the waypoint WP3a is a section for the mobile body 10 to turn back. The waypoint WP3b is located on a side opposite to the waypoint WP0 with respect to the waypoint WP3a.

The out-of-region section R1A in the second embodiment is a section that passes outside the arrangement region AR2, but may pass through the arrangement region AR2, which is different from the arrangement region AR2 in which the target position G is set, in a part of the section.

### Approach Section

The approach section R1B in the first embodiment is configured only with the section that extends in the first direction (X direction) within the installation region AR2, but the approach section RIB in the second embodiment is different from the approach section R1B in the first embodiment in that the approach section R1B includes a section that extends in the second direction (in the present example, the Y direction or the direction opposite to the Y direction) within the installation region AR2. Specifically, the approach section R1B in the second embodiment enters the arrangement region AR2 from the second direction (the Y direction or the direction opposite to the Y direction) and reaches the target position G through the unit region A in which the other object is not arranged.

More specifically, the approach section R1B according to the second embodiment includes a first approach section R1Bc and a second approach section R1Bd. The first approach section R1Bc is a section that enters the arrangement region AR2 from the second direction (the Y direction or the direction opposite to the Y direction) and reaches the immediately preceding position through the unit region A in which the other object is not arranged. More specifically, the first approach section R1Bc is a section connected to the out-of-region section RIA, and is a section in which the entry start position is a starting point and the immediately preceding position is an end point. The first approach section R1Bc extends along the Y direction from the entry start position to the immediately preceding position. In addition, when the section for turning back is not included in the out-of-region section R1A, the section for turning back may be included in the approach section R1B.

In the example of FIG. 9, the first approach section R1Bc in which the unit region A₁₅ is the target position G includes the section for turning back. The first approach section R1Bc includes a section along the Y direction that connects the waypoint WP2a, which is the entry start position, to the waypoint W2c through the waypoint W2b, which is the immediately preceding position, and a section returning from the waypoint W2c to the waypoint W2b. A waypoint W2c is a waypoint adjacent to the waypoint W2b on the side opposite to the Y direction. The section from the waypoint WP2a to the waypoint W2c is the section for moving with the front direction in which the fork 24 is not provided, as the running direction, and the section from the waypoint W2c to the waypoint W2b is the section for turning back. In addition, in the example of FIG. 9, the first approach section R1Bc in which the unit region A₅₅ is the target position G does not include the section for turning back. The first approach section R1Bc is a section along the Y direction that connects the waypoint WP3a, which is the entry start position, to the waypoint WP3c, which is the immediately preceding position.

The second approach section R1Bd is a section that reaches the target position G from the immediately preceding position toward the X direction. The second approach section R1Bd is connected to the first approach section R1Bc. That is, the second approach section R1Bd is a section along the X direction that connects the immediately preceding position to the target position G. In the example of FIG. 9, the second approach section R1Bd in which the unit region A₁₅ is the target position G is a section that connects the waypoint WP2b, which is the immediately preceding position, and the waypoint WPG in the unit region A₁₅ that is the target position G. Similarly, in the example of FIG. 9, the second approach section R1Bd in which the unit region A₅₅ is the target position G is a section that connects the waypoint WP3c, which is the immediately preceding position, and the waypoint WPG in the unit region A₅₅ that is the target position G.

### Specific Example of Setting of First Route

As described above, in the second embodiment, the first route R1 is set to include the out-of-region section R1A and the approach section R1B. Hereinafter, a specific example of the setting of the first route R1 will be described.

For example, the first route setting unit 64 may set the first route R1 such that the approach section R1B is the shortest without interfering with the other object. That is, when a plurality of candidates for the first route R1 including the out-of-region section R1A and the approach section R1B, which satisfy the conditions described above, can be set, the first route setting unit 64 selects the candidate for the first route R1 in which the approach section RIB is the shortest, from among the candidates for the first route R1, as the first route R1. By shortening the approach section RIB, it is possible to shorten the running distance within the installation region AR2 in which the moving speed is low, and to quickly reach the target position G.

In addition, for example, the first route setting unit 64 may acquire the information on the moving speed within the installation region AR2 and the information on the moving speed outside the installation region AR2 (within the normal region AR1), and set the first route R1 such that a predicted reach time to the target position G is shortest, based on the information on the moving speed. The first route setting unit 64 may acquire the information on the moving speed within the installation region AR2 and within the installation region AR2 using any method, and, for example, may acquire the information on the moving speed set in advance. The first route setting unit 64 calculates a predicted time necessary for the movement of the out-of-region section R1A based on the moving speed outside the installation region AR2, and calculates a predicted time necessary for the movement of the approach section R1B based on the moving speed within the installation region AR2, thereby deriving a combination of the out-of-region section R1A and the out-of-region section R1A, in which a total value (predicted reach time) of the predicted times is minimized, for example, by optimization calculation or the like. The first route setting unit 64 sets the out-of-region section R1A in which the predicted reach time is minimized and the out-of-region section R1A, as the first route R1. In this manner, the first route R1 is set such that the predicted reach time is minimized, so that it is possible to quickly reach the target position G.

In addition, for example, the first route setting unit 64 may set the first route R1 in accordance with a relative position of the target position G within the installation region AR2, in other words, in accordance with the position of the unit region A that is the target position G within each unit region A. In this case, it is preferable that unloading is controlled so that the object P is unloaded in a forward manner in each unit region A of the installation line AL when the object P is unloaded in the installation region AR2. The loading in a forward manner means unloading the object P first from the unit region A on the side opposite to the X direction within the installation line AL, in other words, unloading the object P in the unit region A located farthest on the side opposite to the X direction in which the object P is not placed, within the installation line AL. In addition, in this case, it is preferable that the loading is controlled such that the object P is loaded first from the unit region A on the side opposite to the X direction within the installation line AL when the object P is loaded from the installation region AR2. In other words, the object P is loaded from the unit region A located farthest on the side opposite to the X direction in which the object P is placed, on the installation line AL.

A specific example of the method of setting the first route R1 in accordance with the position of the unit region A that is the target position G will be described. The first route setting unit 64 acquires a relative position j of the unit region A (waypoint WP) that is the target position G in the X direction within the installation region AR2 and a relative position i of the unit region A (waypoint WP) that is the target position G in the Y direction within the installation region AR2. The relative position j is information indicating, among the unit regions A (waypoints WP) within the installation line AL, the ordinal position of the unit region A (waypoint WP) that is the target position G when counted from the direction opposite to the X direction. In addition, when the installation region AR2 is located on the Y direction side with respect to the movement source S, the relative position i is information indicating, among the installation lines AL, the ordinal position of the installation line AL including the unit region A that is the target position G when counted from the Y direction. That is, in the example of FIG. 9, when the target position G is the unit region A₁₅, the relative position i is 1 and the relative position j is 5.

When the relative position j in the X direction is equal to or less than 2, the first route setting unit 64 sets the approach section R1B (first route R1) that enters the arrangement region AR2 only from the X direction as in the first embodiment without setting the approach section RIB that enters the arrangement region AR2 from the direction opposite to the Y direction as described in the second embodiment.

On the other hand, when the relative position j in the X direction is equal to or greater than 3, the first route setting unit 64 sets the first route to include the approach section R1B that enters the arrangement region AR2 from the direction opposite to the Y direction, as described in the second embodiment. More specifically, when the relative position i is less than a value obtained by dividing the total number of installation lines AL by 2, and a first condition in which the other object is not arranged on all the installation lines AL on the Y direction side with respect to the relative position i and a second condition in which the other object is not arranged in the unit region A on the side opposite to the X direction with respect to the relative position j in the unit region A among all the installation lines AL are satisfied, the first route setting unit 64 sets the first route R1 as follows. That is, in this case, the first route setting unit 64 selects, as the immediately preceding position, the unit region A_{(i, j-2)} (waypoint WP) that is two units away from the relative position j on the side opposite to the X direction, and selects, as the entry start position, the waypoint WP, which overlaps the immediately preceding position in the X direction, among the waypoints WP within the normal region AR1 adjacent to the installation region AR2 on the Y direction side. That is, in the example of FIG. 9, when the unit region A₁₅ is the target position G, the unit region A₁₃ (waypoint WP2b) is the immediately preceding position, and the waypoint WP2a, which overlaps the unit region A₁₃ in the X direction, is the entry start position. Further, the first route setting unit 64 determines whether a third condition in which the object P is not located in the unit region A_{(i+1, j-2)} (waypoint WP) that is one unit away from the relative position i on the side opposite to the Y direction and two units away from the relative position j on the side opposite to the X direction is satisfied. When the object P is not located in the unit region A_{(i+1, j-2)}, the first route R1 is set by setting the unit region A_{(i+1, j-2)} as the position for turning back. In the example of FIG. 9, when the unit region A₁₅ is the target position G, the object P is not located in the unit region A₂₃, and thus the waypoint WP2c in the unit region A₂₃ is set as the position for turning back.

When the third condition in which the object P is not located in the unit region A_{(i+1, j-2)} is not satisfied, the first route setting unit 64 sets the first route R1 by setting the waypoint WP (in the example of FIG. 9, a waypoint WP2d) overlapping the unit region A_{(i, j-1)} (in the example of FIG. 9, the unit region A₁₄) in the X direction, among the waypoints WP within the normal region AR1 adjacent to the installation region AR2 on the Y direction side, as the position for turning back.

Meanwhile, when the relative position i is greater than the value obtained by dividing the total number of installation lines AL by 2, and a fourth condition in which the other object is not arranged on all the installation lines AL on the direction side opposite to the Y direction side with respect to the relative position i and a fifth condition in which the other object is not arranged in the unit region A on the side opposite to the X direction with respect to the relative position j in the unit region A among all the installation lines AL are satisfied, the first route R1 is set as follows. That is, in this case, the first route setting unit 64 selects, as the immediately preceding position, the unit region A_{(i, j-2)} (waypoint WP) that is two units away from the relative position j on the side opposite to the X direction, and selects, as the entry start position, the waypoint WP, which overlaps the immediately preceding position in the X direction, among the waypoints WP within the normal region AR1 adjacent to the installation region AR2 on the side opposite to the Y direction side. That is, in the example of FIG. 9, when the unit region A₅₅ is the target position G, the unit region A₅₃ (waypoint WP3c) is the immediately preceding position, and the waypoint WP3a, which overlaps the unit region A₅₃ in the X direction, is the entry start position. Further, the first route setting unit 64 determines whether a sixth condition in which the object P is not located in the unit region A_{(i-1, j-2)} (waypoint WP) that is one unit away from the relative position i on the side opposite to the Y direction and two units away from the relative position j on the side opposite to the X direction is satisfied. When the object P is not located in the unit region A_{(i-1, j-2)} (in the example of FIG. 9, the unit region A₄₃), the first route R1 is set by setting the unit region A_{(i-1, j-2)} as the position for turning back.

When the sixth condition in which the object P is not located in the unit region A_{(i-1, j-2)} is not satisfied, the first route setting unit 64 sets the first route R1 by setting the waypoint WP overlapping the unit region A_{(i, j-1)} (in the example of FIG. 9, the unit region A₁₄) in the X direction, among the waypoints WP within the normal region AR1 adjacent to the installation region AR2 in the direction opposite to the Y direction side, as the position for turning back. In the example of FIG. 9, when the unit region A₅₅ is the target position G, the object P is located in the unit region A₄₃, and thus the waypoint WP3b overlapping the unit region A₅₄ in the X direction is set as the position for turning back.

### Setting of Second Route

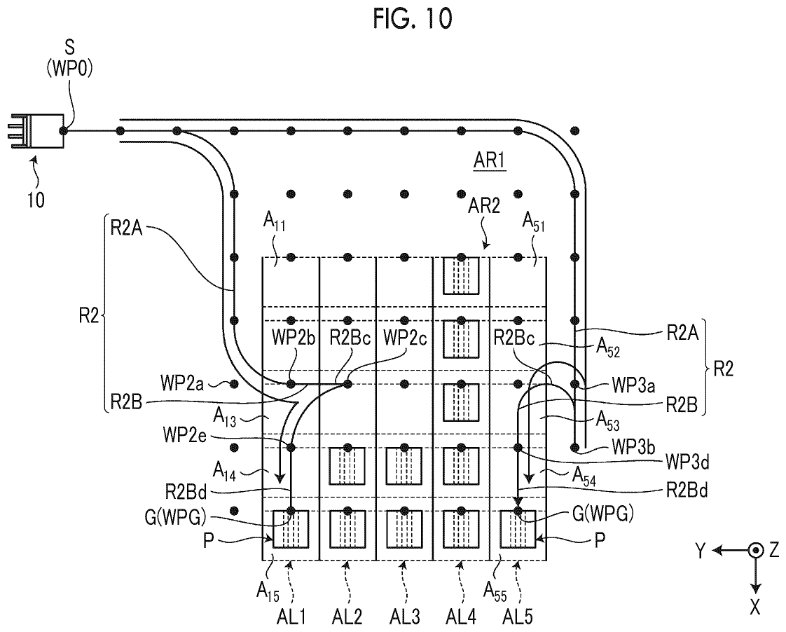

FIG. 10 is a schematic diagram showing an example of the second route. The second route setting unit 82 of the mobile body 10 sets the second route R2 based on the first route R1. The method of setting the second route R2 based on the first route R1 is the same as that in the first embodiment.

In the present embodiment, the second route setting unit 82 sets the second route R2 to include the out-of-region section R2A and the approach section R2B.

As in the first embodiment, the out-of-region section R2A in the second embodiment is a section from a position outside the arrangement region AR2 (within the normal region AR1) toward the arrangement region AR2 through the outside of the arrangement region AR2. The out-of-region section R2A of the second embodiment is a section that passes through the normal region AR1 in which the movement source S is a starting point and a position within a predetermined distance range from the entry start position is an end point. In the example of FIG. 10, in the out-of-region section R2A in which the target position G is the unit region A₁₅, the movement source S is a starting point and a position within a predetermined distance range from the waypoint WP2a is an end point. In the example of FIG. 10, the out-of-region section R2A in which the unit region A₅₅ is the target position G has the movement source S as a starting point, turns back at the waypoint WP3b, and has a position within a predetermined distance range from the waypoint WP3a as an end point.

The approach section R2B in the second embodiment enters the arrangement region AR2 from the second direction (the Y direction or the direction opposite to the Y direction) and reaches the target position G through the unit region A in which the other object is not arranged.

More specifically, the approach section R2B according to the second embodiment includes a first approach section R2Bc and a second approach section R2Bd. The first approach section R2Bc is a section that enters the arrangement region AR2 from the second direction (the Y direction or the direction opposite to the Y direction) and reaches a position within a predetermined distance range from the immediately preceding position through the unit region A in which the other object is not arranged. More specifically, the first approach section R1Bc is a section in which a position within a predetermined distance range from the entry start position is a starting point and a position within a predetermined distance range from the immediately preceding position is an end point. In the example of FIG. 10, the first approach section R1Bc in which the unit region A₁₅ is the target position G has a position within a predetermined distance range from the waypoint WP2a as a starting point, advances toward the side opposite to the Y direction to enter the arrangement region AR2, turns back at the waypoint WP2c, and has a waypoint WP2e in the unit region A₁₄ as an end point. Similarly, in the example of FIG. 10, the first approach section R1Bc in which the unit region A₅₅ is the target position G has the position within the predetermined distance range from the waypoint WP3a as a starting point, advances toward the Y direction to enter the arrangement region AR2, and has a waypoint WP3d in the unit region A₅₄ as an end point.

The second approach section R2Bd is a section that reaches the target position G toward the X direction. The second approach section R2Bd is connected to the first approach section R2Bc. That is, the second approach section R2Bd is a section along the X direction that connects a position within a predetermined distance range from the immediately preceding position to the target position G. In the example of FIG. 10, the second approach section R2Bd in which the unit region A₁₅ is the target position G is a section that connects the waypoint WP2e and the waypoint WPG in the unit region A₁₅ that is the target position G. Similarly, in the example of FIG. 10, the second approach section R2Bd in which the unit region A₅₅ is the target position G is a section that connects the waypoint WP3d and the waypoint WPG in the unit region A₅₅ that is the target position G.

### Effects

As described above, in the second embodiment, the approach section that passes through the arrangement region AR2 on the route of the mobile body 10 is set based on the information on the other object. Accordingly, since the running distance in the arrangement region AR2, in which the speed is low, can be appropriately set, it is possible to quickly reach the target position while suppressing interference with the other object. Further, in the second embodiment, the approach section is set to enter the arrangement region AR2 from the second direction and reaches the target position G through the unit region A in which the other object is not arranged. Normally, the movement direction in the arrangement region AR2 is set to the first direction, but, by setting the route that crosses the arrangement region AR2 from the second direction and enters the arrangement region AR2 in this way, it is possible to shorten the running distance within the arrangement region AR2 and to quickly reach the target position.

### Third Embodiment

Hereinafter, a third embodiment will be described. In the third embodiment, the position and the posture of the object P as the transport object are detected, it is determined whether it is necessary to update the route for picking up the object P based on the position and the posture of the object P, and the subsequent control content is set based on the result of determination of whether it is necessary to update the route. In the third embodiment, the parts having the same configurations as those of the first embodiment and the second embodiment will not be described. The third embodiment can be applied to both the first embodiment and the second embodiment.

### Movement Along Second Route

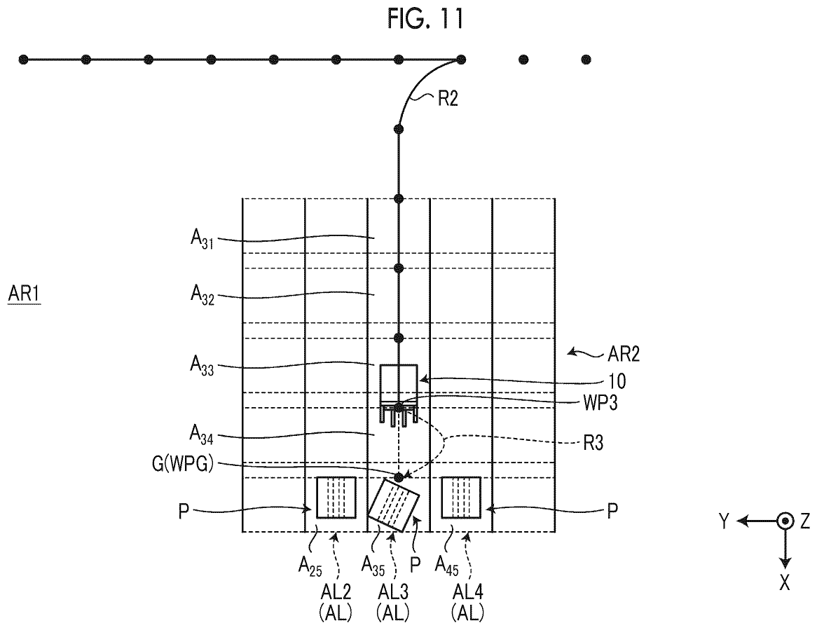

FIG. 11 is a schematic diagram showing an example of control of the mobile body in the third embodiment. In the third embodiment, the movement control unit 84 of the mobile body 10 moves the mobile body 10 along the second route R2 (approach section R2B) set by the method according to the first embodiment or the second embodiment, and causes the mobile body 10 to reach a detection position that is a position on a side opposite to the X direction with respect to the target position G. In the example of FIG. 11, the waypoint WPG in the unit region A₃₅ is set as the target position G, and the mobile body 10 moves along the approach section R2B set by the method according to the first embodiment and reaches the waypoint WP3 (detection position) in the unit region A₃₄ on the side opposite to the X direction with respect to the waypoint WPG in the unit region A₃₅.

### Detection of Object

In the third embodiment, the movement control unit 84 causes the sensor 26A to detect the X direction side of the mobile body 10 at the detection position. For example, when the sensor 26A is configured to emit the laser light, the movement control unit 84 causes the sensor 26A to emit the laser light toward the X direction while performing scanning using the sensor 26A in the lateral direction (horizontal direction). The object P on the X direction side of the detection position reflects the laser light from the sensor 26A. The sensor 26A receives the reflected light from the object P. The movement control unit 84 acquires a point cloud that is a set of measurement points based on the detection result of the reflected light received by the sensor 26A. In the present embodiment, the movement control unit 84 calculates the position (coordinates) of the location in which the reflected light is reflected as the measurement point, based on the detection result of the reflected light. The movement control unit 84 extracts a straight line using, for example, a RANSAC algorithm based on the measurement points (point cloud), and calculates a position and a posture of the straight line as the position and the posture of the front surface Pa of the object P. However, the method of calculating the position and the posture of the front surface Pa of the object P based on the detection result of the sensor 26A may be arbitrary.

In the example of FIG. 10, the movement control unit 84 sets the waypoint WP3 adjacent to the side opposite to the X direction with respect to the waypoint WPG that is the target position G as the detection position, and detects the object P at the detection position, but the position at which the object P is detected is not limited to this and may be any position. The movement control unit 84 may detect the object P at any position at which the target position G can be detected by the sensor 26A, and may detect the object P within the arrangement region AR2 or outside the arrangement region AR2.

### Determination of Whether it is Necessary to set Third Route

The movement control unit 84 determines whether it is necessary to update the route (whether it is necessary to set a third route R3) in order to pick up the object P, based on the position and the posture of the front surface Pa of the object P. More specifically, the movement control unit 84 determines whether the object P can be picked up by continuing the movement along the second route R2. For example, the movement control unit 84 determines whether the positions of the forks 24A and 24B of the fork 24 when the fork 24 has moved along the second route R2 and has reached the object P are shifted from the position of the opening Pb of the front surface Pa of the detected object P. The movement control unit 84 determines that it is not necessary to set the third route R3 when the positions are not shifted, and determines that it is necessary to set the third route R3 is required when the positions are shifted.

### When it is not Necessary to set Third Route

When the movement control unit 84 determines that it is not necessary to set the third route R3, the movement control unit 84 executes the control of continuing the movement along the second route R2 and picking up the object P as the subsequent control.

### When it is Necessary to set Third Route

When it is determined that it is necessary to set the third route R3, the movement control unit 84 sets the third route R3 on which the object P can be picked up, based on the position and the posture of the front surface Pa of the object P. The movement control unit 84 sets a route on which a predetermined position and posture is achieved (position and posture at which the mobile body 10 can pick up the object P) with respect to the position and posture of the detected object P, as the third route R3.

The movement control unit 84 determines whether at least one of the mobile body 10 and the picked-up object P interferes with the other object when the mobile body 10 moves along the set third route R3 to pick up the object P and moves from the picked-up position to another location (for example, returns to the detection position). For example, the movement control unit 84 calculates a region through which the mobile body 10 and the object P pass, based on the third route R3 and the sizes of the mobile body 10 and the object P. Then, the movement control unit 84 calculates whether the region through which the mobile body 10 and the object P pass passes through the unit region A (adjacent unit region) of the installation line AL adjacent to the installation line AL including the target position G. When the region through which the mobile body 10 and the object P pass does not pass through the adjacent unit region (when the mobile body 10 and the object P do not protrude to the adjacent installation line AL), the movement control unit 84 determines that there is no interference with the other object. In addition, the movement control unit 84 determines that there is no interference with the other object when the other object is not arranged in the adjacent unit region even when the region through which the mobile body 10 and the object P pass passes through the adjacent unit region. The movement control unit 84 determines whether the other object is arranged in the adjacent unit region, based on the position information of the other object.

When the movement control unit 84 determines that there is no interference with the other object, the movement control unit 84 switches from the second route R2 to the third route R3 and controls the mobile body 10 so that the mobile body 10 moves along the third route R3 to pick up the object P, as the subsequent control.

On the other hand, when the other object is arranged in the adjacent unit region, the movement control unit 84 determines that there is interference with the other object. When the movement control unit 84 determines that there is interference with the other object, the movement control unit 84 performs predetermined control, which will be described later, as a subsequent operation of the mobile body 10. In the example of FIG. 11, the front surface Pa of the object P arranged in the unit region A₃₅ that is the target position G faces the installation line AL4 side, and since the object P cannot be picked up on the second route R2, the movement control unit 84 determines that it is necessary to set the third route R3. Furthermore, in the example of FIG. 11, since the other object is arranged in the unit region A₄₅ on the installation line AL4 that passes through a region through which the mobile body 10 and the object P pass, the movement control unit 84 determines that there is interference with the other object, and performs the predetermined control described below as the subsequent control.

### Predetermined Control

The predetermined control is control for preventing interference with the other object. Examples of the predetermined control will be described below.

For example, when it is determined that there is interference with the other object, the movement control unit 84 transmits information indicating that there is interference with the other object to the information processing device 14. When the information processing device 14 acquires the information indicating that there is interference with the other object, the information processing device 14 sets a flag indicating that a job of picking up the object P (the object P on the unit region A₃₅ in the example of FIG. 11) is not to be performed. The information processing device 14 may transmit a command to stop the mobile body 10 at the position or may transmit a command to perform a job other than the job of picking up the object P. Here, for the other object (the object P on the unit region A₄₅ in the example of FIG. 11) determined to cause interference, a job of moving the other object to a destination (another location) is set in advance. The information processing device 14 waits for the execution of a job for the other object while setting the flag indicating that the job of picking up the object P is not to be performed without changing the schedule of the job for the other object. When the mobile body (the mobile body 10 or another mobile body) to which the job for the other object is assigned executes the job of moving the other object to the destination, the mobile body transmits information indicating that the other object has been moved, to the information processing device 14. When the information processing device 14 acquires information indicating that the other object has been moved, the information processing device 14 clears the flag indicating that the job of picking up the object P is not to be performed. As a result, the job of picking up the object P is set for the mobile body 10 or another mobile body, and the object P is picked up. That is, in the present example, control of picking up the object P after waiting for the other object that causes interference to move in accordance with a planned schedule is performed. In this manner, the object P can be picked up while suppressing the influence of the job for the other object set in advance on the schedule.

In addition, for example, the schedule of the job of picking up the other object may be changed. In this case, for example, when the information processing device 14 acquires the information indicating that there is interference with the other object, the information processing device 14 resets a start time of the job for the other object determined to cause interference to an earlier time than a preset time while setting the flag indicating that the job of picking up the object P is not to be performed. The mobile body to which the job for the other object is assigned transmits the information indicating that the other object has been moved, to the information processing device 14 when the job of moving the other object to the destination is executed. When the information processing device 14 acquires information indicating that the other object has been moved, the information processing device 14 clears the flag indicating that the job of picking up the object P is not to be performed. As a result, the job of picking up the object P is set for the mobile body 10 or another mobile body, and the object P is picked up. Therefore, according to the present example, it is possible to suppress the delay in the job of picking up the object P. Whether to change the schedule of the job for the other object or whether to change the start time of the job may be determined, for example, based on the priority of the job for the object P. That is, for example, when the information processing device 14 acquires the information indicating there is interference with the other object, the information processing device 14 may acquire information on the priority of the job of the object P set in advance and may reset the start time of the job for the other object to be earlier when the priority satisfies a predetermined condition (for example, when the priority is higher than a predetermined threshold value).

Further, for example, the job of picking up the object P may be resumed after the other object is moved to a location other than the destination. That is, in this case, when the information processing device 14 acquires the information indicating that there is interference with the other object, the information processing device 14 sets a job of moving the other object determined to cause interference to a retreat location other than the destination of the other object, while setting the flag indicating that the job of picking up the object P is not to be performed. The retreat location may be set as appropriate, and may be any position other than the destination of the other object and not overlapping the region through which the mobile body 10 and the object P pass. The information processing device 14 transmits the job of moving the other object to the retreat location to the mobile body 10 or another mobile body. The mobile body that has acquired the job of moving the other object to the retreat location executes the job to move the other object to the retreat location. When the mobile body executes the job of moving the other object to the retreat location, the mobile body transmits the information indicating that the other object has been moved, to the information processing device 14. When the information processing device 14 acquires information indicating that the other object has been moved, the information processing device 14 clears the flag indicating that the job of picking up the object P is not to be performed. As a result, the job of picking up the object P is set for the mobile body 10 or another mobile body, and the object P is picked up. The information processing device 14 also sets a job of moving the other object to the original target position from the retreat location, transmits the job to the mobile body 10 or another mobile body, and causes the mobile body 10 or another mobile body to execute the job. In the present example, since the other object is temporarily moved to the retreat location, the object P can be picked up while suppressing the delay in the job of picking up the object P.

### Control Flow

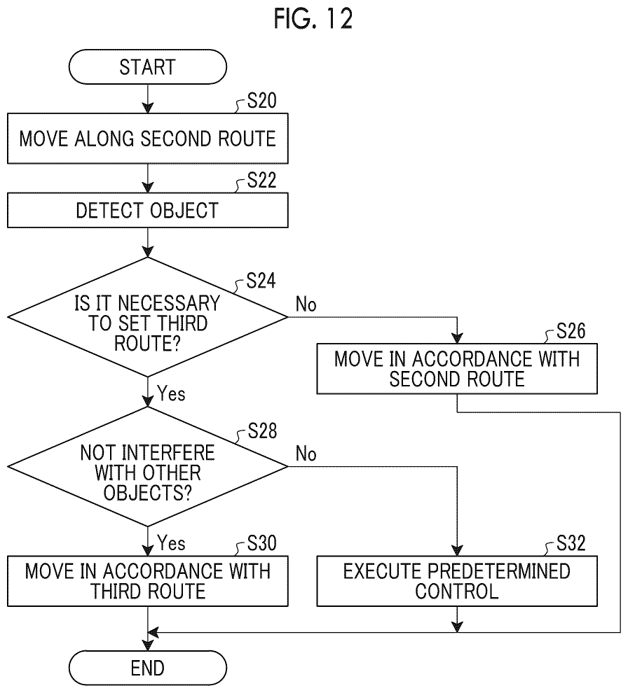

Next, a processing flow in the third embodiment will be described. FIG. 12 is a flowchart showing a processing flow of the movement control system according to the third embodiment. As shown in FIG. 12, the mobile body 10 moves into the installation region AR2 along the second route R2 (step S20), and detects the position and the posture of the object P (step S22). The mobile body 10 may continue to move along the second route R2 until the position and the posture of the object P are detected. The mobile body 10 determines whether it is necessary to set the third route R3, based on the position and the posture of the object P (step S24), and when it is not necessary to set the third route R3 (step S24; No), the mobile body 10 continues to move along the second route R2 to pick up the object P (step S26). On the other hand, when it is necessary to set the third route R3 (step S24; Yes), and there is no interference with the other object even when the third route R3 is used (step S28; Yes), the mobile body 10 switches to the third route R3 and moves along the third route R3 to pick up the object P (step S30). On the other hand, when there is interference with the other object due to the third route R3 (step S28; No), the predetermined control described above is performed (step S32).

### When Side-Shifting is Possible

The mobile body 10 may be capable of side-shifting to move the fork 24 in the left-right direction. When the side-shifting is possible, the movement control unit 84 determines whether the object P can be picked up by moving the fork 24 in the left-right direction using the side-shifting while continuing the movement along the second route R2. The movement control unit 84 may determine that it is not necessary to set the third route R3 when the object P cannot be picked up when the movement along the second route R2 is continued without using the side-shifting, but the object P can be picked up using the side-shifting while the movement along the second route R2 is continued. In this case, the movement control unit 84 sets, as the subsequent control, the pickup of the object P by means of the side-shifting while continuing the movement along the second route R2. On the other hand, when the pickup is not possible even when the side-shifting is used, the movement control unit 84 determines that it is necessary to set the third route R3, and performs the same control as described above.

Further, even when the pickup is possible using the side-shifting, the movement control unit 84 may determine that it is necessary to set the third route R3 and perform the same control as described above when there is no interference with the other object when the third route R3 is used. That is, in this case, the movement control unit 84 sets the third route R3 even when it is determined that the pickup can be performed using the side-shifting. Then, the movement control unit 84 determines whether there is interference with the other object when the third route R3 is used, in the same manner as described above, and when there is no interference with the other object, the movement control unit 84 switches the second route R2 to the third route R3 and moves the mobile body 10 along the third route R3 to pick up the object P, as the subsequent control. On the other hand, when the movement control unit 84 determines that there is interference with the other object when the third route R3 is used, the movement control unit 84 picks up the object P using the side-shifting while the movement along the second route R2 is continued, as the subsequent control. When the side-shifting is used, the object P is picked up in a shifted state, and thus there is a possibility that the position or the posture of the picked-up object P will be shifted when the object P is dropped. Therefore, even when the object P can be picked up using the side-shifting, when there is no interference with the other object when the third route R3 is used, the third route R3 is applied, so that it is possible to prevent the object P from being picked up in a shifted state.

In this way, in the third embodiment, the position and the posture of the object P are detected, it is determined whether it is necessary to set the third route R3 for picking up the object P based on the position and the posture of the object P, and the subsequent control content is set based on the result of determination of whether it is necessary to set the third route R3. Therefore, according to the present embodiment, even when the object P is placed in a shifted manner, the object P can be picked up while suppressing interference with the other object.

### Effects

As described above, a first aspect of the present disclosure relates to a control method for a mobile body 10 that autonomously moves, the control method including: a step of setting a position corresponding to a predetermined unit region A within an arrangement region AR2 in which unit regions A in which an object P is likely to be arranged are aligned in a first direction (X direction), as a target position G of the mobile body 10; a step of acquiring information on another object that is the object P arranged within the unit region A other than the target position G; a step of setting a route of the mobile body toward the target position G through the arrangement region AR2 without interfering with the other object; and a step of moving the mobile body 10 along the route. In this control method, at least one of a moving speed of the mobile body 10 within the arrangement region AR2 and a section (approach section) that passes through the arrangement region AR2 on the route is set based on the information on the other object. According to the present disclosure, the route toward the target position G is set to be directed through the arrangement region AR2 without interfering with the other object. Then, according to the present disclosure, at least one of the moving speed of the mobile body 10 within the arrangement region AR2 and the approach section is set based on the information on the other object. In this manner, it is possible to move in the arrangement region AR2 in which the unit regions are aligned in the X direction, at an appropriate speed or along an appropriate route, and it is possible to quickly reach the target position while suppressing interference with the other object.

A second aspect of the present disclosure relates to the control method according to the first aspect, in which, in the step of setting the route, the route is set to include an approach section that reaches the target position G toward the first direction (X direction) within the arrangement region AR2. According to the present disclosure, the mobile body 10 can appropriately move in the arrangement region AR2 in which the objects P are aligned in the first direction, to reach the target position.

A third aspect of the present disclosure relates to the control method according to the first or second aspect, in which, in the step of moving the mobile body 10, in an approach section that passes through the arrangement region on the route, the moving speed in a first approach section up to an intermediate position through which the mobile body 10 passes before the target position G is set to be higher than the moving speed in a second approach section from the intermediate position to the target position G. That is, according to the present disclosure, it is possible to perform high-speed movement in the first approach section that is located within the arrangement region AR2 but is spaced away from the target position G and to perform low-speed and precise operation in the second approach section that is close to the target position G, and therefore it is possible to quickly reach the target position G while approaching the target position G with high accuracy while avoiding interference with the other object.

A fourth aspect of the present disclosure relates to the control method according to any one of the first to third aspects, in which, in the step of moving the mobile body 10, the moving speed in the first approach section is set based on the information on the other object in the unit regions A located on a side in a second direction (the Y direction side or the direction opposite to the Y direction) intersecting the first direction (X direction) with respect to the first approach section. According to the present disclosure, since the speed in the first approach section is set depending on whether the other object is placed in the adjacent unit region A, it is possible to appropriately reach the target position G while avoiding interference with the other object.

A fifth aspect of the present disclosure relates to the control method according to any one of the first to fourth aspects, in which, in the step of moving the mobile body 10, the moving speed in an out-of-region section that passes through a region outside the arrangement region AR2 on the route is set to be higher than the moving speed in an approach section. Accordingly, it is possible to perform high-speed movement in the normal region AR1 in which the object P is not installed, while performing precise operation in the arrangement region AR2 in which the object P is likely to be installed, and therefore it is possible to quickly reach the target position while suppressing interference with the other object.

A sixth aspect of the present disclosure relates to the control method according to any one of the first to fifth aspects, in which, in the step of setting the route, the route is set to include an approach section that enters the arrangement region AR2 from a second direction (the Y direction side or the direction opposite to the Y direction) intersecting the first direction (X direction) to reach the target position G through the unit region A in which the other object is not arranged. In this way, by setting the route that enters the arrangement region AR2 by crossing from the second direction, it is possible to shorten the running distance within the arrangement region AR2 and quickly reach the target position.

A seventh aspect of the present disclosure relates to the control method according to the sixth aspect, in which, in the step of setting the route, the approach section is set to include a first approach section that enters the arrangement region AR2 from the second direction to reach an immediately preceding position overlapping the unit region A on a direction side opposite to the first direction with respect to the target position through the unit region A in which the other object is not arranged, and a second approach section that reaches the target position G from the immediately preceding position toward the first direction. According to the present disclosure, it is possible to quickly and appropriately reach the target position G by setting the route that enters the arrangement region AR2 by crossing from the second direction and the route that approaches the target position G in the first direction.

An eighth aspect of the present disclosure relates to the control method according to the sixth or seventh aspect, in which, in the step of setting the route, the approach section (route) is set not to interfere with the other object and to be shortest. According to the present disclosure, since the section that passes through the arrangement region AR2 is made as short as possible, it is possible to shorten the running distance within the installation region AR2 in which the moving speed is low and to quickly reach the target position G.

A ninth aspect of the present disclosure relates to the control method according to the sixth or seventh aspect, in which, in the step of setting the route, the route is set to include an out-of-region section that passes through a region outside the arrangement region AR2, information on the moving speed of the mobile body 10 within the arrangement region AR2 and information on the moving speed of the mobile body 10 outside the arrangement region AR2 are acquired, and the out-of-region section and the approach section are set to have a shortest predicted reach time to the target position G, based on the moving speed within the arrangement region AR2 and the moving speed outside the arrangement region AR2. In this way, the route is set to have the shortest predicted reach time, so that it is possible to quickly reach the target position G.

A tenth aspect of the present disclosure relates to the control method according to any one of the first to ninth aspects, in which, in the step of moving the mobile body 10, a position and a posture of the object P that is a transport object are detected, whether it is necessary to update the route for picking up the object P is determined based on the position and the posture of the object P, and subsequent control contents are set based on a result of the determination of whether it is necessary to update the route. According to the present disclosure, even when the object P is placed in a shifted manner, the object P can be picked up while suppressing interference with the other object.

An eleventh aspect of the present disclosure relates to a program causing a computer to execute a control method for a mobile body 10 that autonomously moves, the control method including: a step of setting a position corresponding to a predetermined unit region A in an arrangement region AR2 in which unit regions A in which an object P is likely to be arranged are aligned in a first direction (X direction), as a target position G of the mobile body 10; a step of acquiring information on another object that is the object P arranged within the unit region A other than the target position G; a step of setting a route of the mobile body toward the target position G through the arrangement region AR2 without interfering with the other object; and a step of moving the mobile body 10 along the route. In this program, at least one of a moving speed of the mobile body 10 within the arrangement region AR2 and a section (approach section) that passes through the arrangement region AR2 on the route is set based on the information on the other object. According to the present disclosure, it is possible to move in the arrangement region AR2 in which the unit regions are aligned in the X direction, at an appropriate speed or along an appropriate route, and it is possible to quickly reach the target position while suppressing interference with the other object.

A twelfth aspect of the present disclosure relates to a mobile body 10 that autonomously moves, the mobile body including: a route acquisition unit (first route acquisition unit 80) that acquires a route of the mobile body 10; and a movement control unit 84 that moves the mobile body 10 along the route. By setting a position corresponding to a predetermined unit region A within an arrangement region AR2 in which unit regions A in which an object P is likely to be arranged are aligned in a first direction, as a target position G of the mobile body 10, and acquiring information on another object that is the object P arranged within the unit region A other than the target position G, the route is set to be directed toward the target position G through the arrangement region AR2 without interfering with the other object. At least one of a moving speed of the mobile body 10 within the arrangement region AR2 and a section that passes through the arrangement region AR2 on the route is set based on the information on the other object. According to the present disclosure, it is possible to move in the arrangement region AR2 in which the unit regions are aligned in the X direction, at an appropriate speed or along an appropriate route, and it is possible to quickly reach the target position while suppressing interference with the other object.

Although the embodiments of the present disclosure have been described above, the embodiments are not limited by the contents of the embodiments. In addition, the above-described constituent elements include those that can be easily conceived by a person skilled in the art, those that are substantially identical, and those falling within the so-called scope of equivalents. Further, the above-described constituent elements can be combined as appropriate. Furthermore, various omissions, replacements, or modifications of the above-described constituent elements can be made without departing from the gist of the above-described embodiments.

### REFERENCE SIGNS LIST

10: mobile body
12: management device
14: information processing device
A: unit region
AL: installation line
AR1: normal region
AR2: installation region
G: target position
P: object
WP: waypoint

1. A control method for a mobile body that autonomously moves, the control method comprising:
a step of setting a position corresponding to a predetermined unit region within an arrangement region in which a plurality of installation lines, in which unit regions in which an object is likely to be arranged are aligned in a first direction, are aligned in a second direction intersecting the first direction, as a target position of the mobile body;
a step of acquiring information on another object that is the object arranged within the unit region other than the target position;
a step of setting a route of the mobile body toward the target position to the first direction within the arrangement region without interfering with the other object; and
a step of moving the mobile body along the route,
wherein, in the step of acquiring the information on the other object, the information on the other object in an adjacent unit region is acquired, the adjacent unit region being a unit region located on a side in the second direction and on a direction side opposite to the first direction with respect to the target position, and
at least one of a moving speed of the mobile body within the arrangement region and a section that passes through the arrangement region on the route is set based on the information on the other object in the adjacent unit region.

2. The control method according to claim 1,
wherein, in the step of setting the route, the route is set to include an approach section that reaches the target position toward the first direction within the arrangement region.

3. The control method according to claim 1,
wherein, in the step of moving the mobile body, in an approach section that passes through the arrangement region on the route, the moving speed in a first approach section up to an intermediate position through which the mobile body passes before the target position is set to be higher than the moving speed in a second approach section from the intermediate position to the target position.

4. The control method according to claim 3,
wherein, in the step of moving the mobile body, the moving speed in the first approach section is set based on the information on the other object in the unit region located on a side in the second direction with respect to the first approach section.

5. The control method according to claim 1,
wherein, in the step of moving the mobile body, the moving speed in an out-of-region section that passes through a region outside the arrangement region on the route is set to be higher than the moving speed in an approach section that passes through the arrangement region.

6. The control method according to claim 1,
wherein, in the step of setting the route, the route is set to include an approach section that enters the arrangement region from the second direction to reach the target position through the unit region in which the other object is not arranged.

7. The control method according to claim 6,
wherein, in the step of setting the route, the approach section is set to include
a first approach section that enters the arrangement region from the second direction to reach an immediately preceding position overlapping the unit region on a direction side opposite to the first direction with respect to the target position through the unit region in which the other object is not arranged, and
a second approach section that reaches the target position from the immediately preceding position toward the first direction.

8. The control method according to claim 6,
wherein, in the step of setting the route, the approach section is set not to interfere with the other object and to be shortest.

9. The control method according to claim 6,
wherein, in the step of setting the route,
information on the moving speed of the mobile body within the arrangement region and information on the moving speed of the mobile body outside the arrangement region are acquired, and
an out-of-region section that passes through a region outside the arrangement region and the approach section are set to have a shortest predicted reach time to the target position, based on the moving speed within the arrangement region and the moving speed outside the arrangement region.

10. The control method according to claim 1,
wherein, in the step of moving the mobile body,
a position and a posture of the object that is a transport object are detected,
whether it is necessary to update the route for picking up the object is determined based on the position and the posture of the object, and
subsequent control contents are set based on a result of the determination of whether it is necessary to update the route.

11. A computer-readable recording medium having stored thereon a program causing a computer to execute a control method for a mobile body that autonomously moves, the control method comprising:
a step of setting a position corresponding to a predetermined unit region within an arrangement region in which a plurality of installation lines, in which unit regions in which an object is likely to be arranged are aligned in a first direction, are aligned in a second direction intersecting the first direction, as a target position of the mobile body;
a step of acquiring information on another object that is the object arranged within the unit region other than the target position;
a step of setting a route of the mobile body toward the target position to the first direction within the arrangement region without interfering with the other object; and
a step of moving the mobile body along the route,
wherein, in the step of acquiring the information on the other object, the information on the other object in an adjacent unit region is acquired, the adjacent unit region being a unit region located on a side in the second direction and on a direction side opposite to the first direction with respect to the target position, and
at least one of a moving speed of the mobile body within the arrangement region and a section that passes through the arrangement region on the route is set based on the information on the other object in the adjacent unit region.

12. A mobile body that autonomously moves, the mobile body comprising:
a route acquisition unit that acquires a route of the mobile body; and
a movement control unit that moves the mobile body along the route,
wherein, by setting a position corresponding to a predetermined unit region within an arrangement region in which a plurality of installation lines, in which unit regions in which an object is likely to be arranged are aligned in a first direction, are aligned in a second direction intersecting the first direction, as a target position of the mobile body, and acquiring information on another object that is the object arranged within the unit region other than the target position, the route is set to be directed toward the target position to the first direction within the arrangement region without interfering with the other object, and
at least one of a moving speed of the mobile body within the arrangement region and a section that passes through the arrangement region on the route is set based on the information on the other object in an adjacent unit region that is a unit region located on a side in the second direction and on a direction side opposite to the first direction with respect to the target position.
